(19) United States
(12) Patent Application Publication
(10) Pub. No.: US 2018/0129741 A1
(43) Pub. Date: May 10, 2018

(54) TRANSMISSION APPARATUS, INFORMATION PROCESSING SYSTEM, AND TRANSMISSION METHOD

(71) Applicant: FUJITSU LIMITED, Kawasaki-shi (JP)

(72) Inventors: Takuya Sato, Yokohama (JP); Takahiro Notsu, Kawasaki (JP); Mitsuru Tomono, Higashimurayama (JP); Makoto Mori, kawasaki (JP)

(73) Assignee: FUJITSU LIMITED, Kawasaki-shi (JP)

(21) Appl. No.: 15/784,648

(22) Filed: Oct. 16, 2017

(30) Foreign Application Priority Data
Nov. 9, 2016 (JP) 2016-218577

(51) Int. Cl. G06F 17/30; H04W 12/02; H04L 29/08; H04W 84/18

(52) U.S. Cl. CPC G06F 17/30781; H04W 12/02; H04W 52/04; H04W 84/18; H04L 67/12

(57) ABSTRACT

A transmission apparatus includes a processor configured to: disable access to a third memory, store input first data in the first memory, generate second data based on the first data, store the second data in a second memory, and in a case where the second data exhibits abnormality, store, in the third memory, the first data stored in the first memory, enable a process of transmitting, perform the process of transmitting the second data stored in the second memory and transmitting the first data stored in the third memory, and exclusively enable access to the first memory and the process of the transmitting, and enable the access to the third memory in accordance with the abnormality.

### CROSS-REFERENCE TO RELATED APPLICATION

This application is based upon and claims the benefit of priority of the prior Japanese Patent Application No. 2016-218577, filed on Nov. 9, 2016, the entire contents of which are incorporated herein by reference.

### FIELD

The embodiments discussed herein are related to a transmission apparatus, an information processing system, and a transmission method.

### BACKGROUND

Recently, various types of electric equipment are connected to a network. A system in which a server computer remotely controls pieces of electric equipment connected to a network is also provided. For example, a system called as a connected home (or smart home) is considered.

In the connected home, energy supplied to a house or a household electric appliance in the house is automatically controlled and thus safe and comfortable residence is realized. In the connected home, information regarding the location and an activity state of a user in a residence is detected by a sensor that senses sound, heat, or the like, pieces of detected information are collected and analyzed by a server computer, and thus a household electric appliance may be controlled.

Among pieces of data collected by the system described above, data having high confidentiality, for example, information regarding privacy of the user is also provided. Thus, a method of ensuring security of collected pieces of data is considered.

For example, an image surveillance apparatus that acquires an image obtained by an image sensor capturing an image of a surveillance area, and transmits the captured image through a communication line is suggested. In the image surveillance apparatus, it is assumed that an image is not sent out when the state of a surveillance area is a normal state or when vigilance in a guard mode is released. Thus, in an unnecessary case in security, an image of a surveillance target is not viewed to an observer in the outside, for example, a guard center.

In addition, a surveillance system in which an image captured by a surveillance camera is transmitted to a surveillance center only in a case where it is determined to be in a state where fire occurs, by a terminal apparatus having the surveillance camera is also suggested. There is also a suggestion as follows. An image of facilities as a surveillance target is captured by a camera after urgent earthquake warning, and an image of the facilities is also captured by the camera after a seismic sensor detects that the major movements of the earthquake is reached. It is determined whether or not the facilities are damaged by the fire, in accordance with a difference between both the captured image data, and a surveillance center is notified of the determination result.

Further, a video surveillance and recording system in which, regarding an access via an input and output channel of a storage device on an external network side thereof, reading is set to be allowed and writing is restricted, and thus tampering of a surveillance video stored in the storage device through the external network is suppressed is also suggested.

Japanese Laid-open Patent Publication No. 11-328547, Japanese Laid-open Patent Publication No. 2004-56443, Japanese Laid-open Patent Publication No. 2009-2914, and Japanese Laid-open Patent Publication No. 2002-247561 are examples of the related art.

As described above, a system in which pieces of input data (data of an image, sound, or the like relating to privacy of a user) input from a sensor and the like are collected and thus control of devices or surveillance is performed is considered. In such a system, it is considered that, normally, predetermined data (for example, context data for controlling a device) is generated from input data by a transmission apparatus connected to a sensor, and the generated data is transmitted to a server or the like. It is considered that, when abnormality occurs, input data itself is transmitted to the server or the like by the transmission apparatus, and thus an observer is allowed to appropriately understand the abnormality and appropriately deal with the abnormality. In this manner, transmission of input data is limited to be performed when abnormality occurs, and thus leakage of information regarding privacy of a user may be restricted. Meanwhile, even though contents of transmission data are controlled by a function of the transmission apparatus, a risk that the function is altered by an unauthorized access and thus information is leaked remains.

Specifically, in a transmission apparatus, input data is temporarily held in a memory. Therefore, there is a problem in that, if an unauthorized access to the transmission apparatus occurs, input data stored in the memory may be leaked to the outside of the apparatus without restriction.

### SUMMARY

According to an aspect of the embodiments, a transmission apparatus includes a processor configured to: disable access to a third memory, store input first data in the first memory, generate second data based on the first data, store the second data in a second memory, and in a case where the second data exhibits abnormality, store, in the third memory, the first data stored in the first memory, enable a process of transmitting, perform the process of transmitting the second data stored in the second memory and transmitting the first data stored in the third memory, and exclusively enable access to the first memory and the process of the transmitting, and enable the access to the third memory in accordance with the abnormality.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a transmission apparatus according to a first embodiment;

FIG. 2 is a diagram illustrating an example of a connected home system according to a second embodiment;

FIG. 3 is a diagram illustrating a hardware example of a sensor device in the second embodiment;

FIG. 4 is a diagram illustrating an example of a power control section in the second embodiment;

FIG. 5 is a diagram illustrating a hardware example of a home server in the second embodiment;

FIG. 6 is a diagram illustrating a hardware example of a household electric appliance in the second embodiment;

FIG. 7 is a diagram illustrating a function example of the home server in the second embodiment;

FIG. 8 is a diagram illustrating a function example of a central server in the second embodiment;

FIG. 9 is a diagram illustrating an example of a context conversion table in the second embodiment;

FIG. 10 is a diagram illustrating an example of power control (Pattern 1) in the second embodiment;

FIG. 11 is a flowchart illustrating a transmission processing example of the power control (Pattern 1);

FIG. 12 is a diagram illustrating a state transition example of the sensor device in the power control (Pattern 1);

FIG. 13 is a diagram illustrating an example of power control (Pattern 2) in the second embodiment;

FIG. 14 is a flowchart illustrating a transmission processing example of the power control (Pattern 2);

FIG. 15 is a diagram illustrating a state transition example of the sensor device in the power control (Pattern 2);

FIG. 16 is a diagram illustrating an example of power control (Pattern 3) in the second embodiment;

FIG. 17 is a flowchart illustrating a transmission processing example of the power control (Pattern 3);

FIG. 18 is a diagram illustrating a state transition example of the sensor device in the power control (Pattern 3);

FIG. 19 is a diagram illustrating a hardware example of a sensor device in a third embodiment;

FIG. 20 is a flowchart illustrating a transmission processing example of the power control (Pattern A); and

FIG. 21 is a flowchart illustrating a transmission processing example of the power control (Pattern B).

### DESCRIPTION OF EMBODIMENTS

Hereinafter, embodiments will be described with reference to the drawings.

### First Embodiment

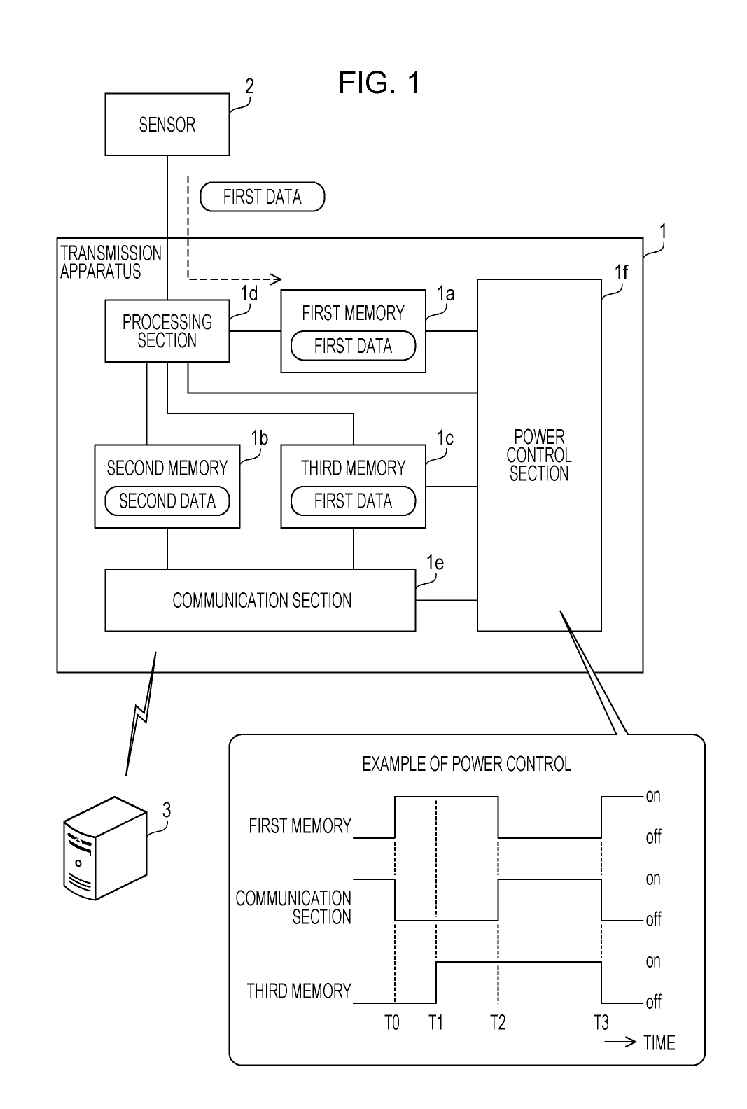

FIG. 1 is a diagram illustrating a transmission apparatus according to a first embodiment. A transmission apparatus 1 is connected to a sensor 2. The transmission apparatus 1 communicates with an information processing apparatus 3. The transmission apparatus 1 controls transmission of first data acquired from the sensor 2, and second data generated based on the first data, to the information processing apparatus 3. The first data is data generated by the sensor 2. The first data may be referred to as sensor data. The second data is data used in predetermined control by the information processing apparatus 3. The second data may be referred to as context data.

Here, the sensor 2 is a device as an input source of data for the transmission apparatus 1. The sensor 2 is an image sensor mounted in a camera, for example. In this case, the first data is image data generated by the image sensor. For example, the sensor 2 may be provided in a predetermined facility (for example, house, health facility, or the like) and may generate image data (still image, video, or the like) of a user in the facility. The image data may include an image of the user. The sensor 2 may be a sensor that detects another physical phenomenon such as sound or a temperature. The first data may be audio data, temperature distribution data, or the like. The sensor 2 may be mounted in the transmission apparatus 1.

Normally, the information processing apparatus 3 receives second data transmitted by the transmission apparatus 1 and controls an operation of another device in accordance with the second data. The information processing apparatus 3 receives first data transmitted by the transmission apparatus 1 and recognizes details of abnormality, when the abnormality occurs.

As described above, the transmission apparatus 1 controls data to be transmitted to the information processing apparatus 3, in accordance with a case of a normal time and a case of an abnormal time. The transmission apparatus 1 temporarily holds first data input from the sensor 2. As described above, the first data may include information regarding privacy of a user. Since the transmission apparatus 1 includes a communication function, an unauthorized access to the transmission apparatus 1 may occur. Thus, the transmission apparatus 1 provides a function of reducing a risk of leakage of information by the unauthorized access.

The transmission apparatus 1 includes a first memory 1a, a second memory 1b, a third memory 1c, a processing section 1d, a communication section 1e, and a power control section 1f. The first memory 1a, the second memory 1b, and the third memory 1c are volatile storage devices (volatile memories). For example, the first memory 1a, the second memory 1b, and the third memory 1c are static random-access memories (SRAMs).

The processing section 1d is realized by a processor such as a field programmable gate array (FPGA), a digital signal processor (DSP), an application specific integrated circuit (ASIC), or a central processing unit (CPU), or any combination thereof. The processor may be an assembly (multiprocessor) of a plurality of processors.

Similar to the processing section 1d, the communication section 1e and the power control section 1f are also realized by at least one processor such as a FPGA, an ASIC, and/or a central processing unit (CPU).

As the processor of each of the processing section, the communication section, and the power control section, one or two processor may be used together, or three separate processors may be employed. Regarding the power control section 1f, a processor realized by a hard-wired logic is preferably employed. That is, for the power control section 1f, a processor in which subsequent overwriting of a logic by an unauthorized access or the like is not performed is preferably used. For example, it is considered that a FPGA in which logic data is written at a manufacturing point such as a factory, in a manner of one-time flash is used as a power control section 1f. The reason is because subsequent tampering of a logic is suppressed and power control which will be described later is appropriately performed.

The communication section 1e, the power control section 1f, and the processing section 1d may be collectively referred to as a handling section. The handing section may include a processor that has functions of the processing section 1d, the power control section 1f, and the communication section 1e. The first memory 1a stores first data input from the sensor 2. For example, the first memory 1a may store data corresponding to a length of one frame to about several frames (old data is overwritten as new data).

The second memory 1b stores second data generated by the processing section 1d. The second data is data having a size which is smaller than that of the first data. It is preferable that the memory capacity of the second memory 1b is set to have the minimum size desired for storing the second data.

The third memory 1c stores the first data when abnormality occurs. The data volume of the first data which is transmitted to the information processing apparatus 3 by the transmission apparatus 1 when abnormality occurs is predetermined (for example, the data volume thereof is determined in accordance with the length of time corresponding to a still image, a video, or the like which is transmitted). It is preferable that the memory capacity of the third memory 1c is set to have the minimum size desired for storing the data volume of data transmitted when abnormality occurs.

The processing section 1d stores first data input from the sensor 2, in the first memory 1a. Pieces of the first data are sequentially input in accordance with sensing by the sensor 2. The input first data is firstly stored in the first memory 1a so as to perform buffering.

The processing section 1d generates second data based on the first data which has been stored in the first memory 1a. For example, the processing section 1d outputs the second data by performing predetermined computation processing with the first data. For example, the computation processing may be processing of detecting a time series change or the like of the pieces of first data which have been sequentially input.

The second data also indicates a situation of a user, for example, in which the user is present or is not present, or in which the user stays for a long time. The second data also indicates abnormality of a user, for example, in which the user abnormally does, or in which the user abnormally stays long at a location at which the user may not stay for a long time. The processing section 1d stores the generated second data, in the second memory. In a case where the second data exhibits abnormality, the processing section 1d stores the first data stored in the first memory 1a, in the third memory.

The communication section 1e communicates with the information processing apparatus 3. The communication section 1e transmits the second data stored in the second memory 1b, to the information processing apparatus 3. The communication section 1e transmits the first data stored in the third memory 1c, to the information processing apparatus 3.

The power control section 1f performs power control of the first memory 1a, the second memory 1b , the third memory 1c, the processing section 1d, and the communication section 1e . It is considered that the second memory 1b and the processing section 1d are in a state of power ON, so long as particular statements are not made. The third memory 1c is normally in a state of power OFF. The reason is because excessive storing of first data in the third memory 1c by the processing section 1d is suppressed. The power control section 1f performs first control and second control which will be described later.

The first control is control in which the power of the first memory 1a and the communication section 1e is caused to exclusively turn ON. In the result, the first memory becomes enabled to access. That is, in a case where the power of the first memory 1a is caused to turn ON, the power control section 1f causes the power of the communication section 1e to turn OFF. In the result, the process of the communication section 1e becomes disabled. In a case where the power control section 1f causes the power of the communication section 1e to turn ON, the power control section 1f causes the power of the first memory 1a to turn OFF.

In the first control, the power control section 1f switches ON and OFF of the power of the first memory 1a and the communication section 1e at a timing corresponding to a notification from the processing section 1d or the communication section 1e. For example, in a case where the second data exhibits normality, the power control section 1f receives a notification indicating that generation of the second data and storing of the second data in the second memory 1b are completed, from the processing section 1d. Then, the power control section 1f causes the power of the first memory 1a to turn OFF and causes the power of the communication section 1e to turn ON. In the result, the process of the communication section 1e is enabled.

The power control section 1f receives a notification indicating that transmission of the second data is completed, from the communication section 1e. Then, the power control section 1f causes the power of the communication section 1e to turn OFF and causes the power of the first memory 1a to turn ON.

The second control is control in which the power of the third memory 1c is caused to turn ON in accordance with the abnormality. In the second control, the power control section 1f causes the power of the third memory 1c to turn ON at a timing corresponding to a notification from the processing section 1d. For example, the power control section 1f receives a notification indicating that abnormality is detected based on the second data, from the processing section 1d, and then causes the power of the third memory 1c to turn ON. If the power of the third memory 1c is caused to turn ON, the first data stored in the first memory 1a may be stored in the third memory 1c by the processing section 1d.

In a case where the power control section 1f performs the second control, the power control section 1f may cause the power of the first memory 1a and the communication section 1e to exclusively turn ON by the first control. For example, the power control section 1f causes the power of the first memory 1a to turn OFF after the power control section 1f receives a notification of abnormality from the processing section 1d, and before the power control section 1f causes the power of the communication section 1e to turn ON. Then, the power control section 1f causes the power of the first memory 1a to turn ON after the power control section 1f causes the power of the third memory 1c and the communication section 1e to turn OFF. In this case, the power control section 1f may perform control to cause the power of the third memory 1c and the communication section 1e to turn OFF and cause the power of the first memory 1a to turn ON, in a case where an input of a predetermined operation by a user (or person who deals with the countermeasures for abnormality) for the transmission apparatus 1 is received. The transmission apparatus 1 may include an operation section (for example, a button which may be pressed by a user) for receiving the input of the operation.

FIG. 1 illustrates an example of power control of the first memory 1a, the third memory 1c, and the communication section 1e, which is performed by the power control section 1f. A clockwise direction of the time is a direction from the left (time point T0 side) toward the right (time point T3 side). A power state of each of the sections with time series of time points T0, T1, T2, and T3 will be described below. In FIG. 1, power ON is indicated by “on” and power OFF is indicated by “off”.

Just before the time point T0, the second data stored in the second memory 1b is transmitted by the communication section 1e, as processing for the normal time. Just before the time point T0, the power of the first memory 1a is in an OFF state, the power of the communication section 1e is in an ON state, and the power of the third memory 1c is in an OFF state.

The power control section 1f causes the power of the communication section 1e to turn OFF and causes the power of the first memory 1a to turn ON, at the time point T0. After the time point T0, the processing section 1d stores first data input from the sensor 2, in the first memory 1a, and generates second data based on the first data which has been stored in the first memory 1a. The processing section 1d stores the second data in the second memory 1b. Here, the processing section 1d detects that the second data exhibits abnormality. The processing section 1d notifies the power control section 1f to detect abnormality.

The power control section 1f causes the power of the third memory 1c to turn ON at a time point T1, in accordance with a notification of the abnormality by the processing section 1d. The processing section 1d stores new first data input from the sensor 2, in the first memory 1a even for the period. The processing section 1d starts storing of the first data stored in the first memory 1a, in the third memory 1c. Here, an acquisition time ΔT of the first data satisfies ΔT=T2−T1. ΔT is predetermined. ΔT is, for example, about several seconds.

The power control section 1f causes the power of the first memory 1a to turn OFF and causes the power of the communication section 1e to turn ON, at a time point T2. Since holding of the first data input by the first memory 1a is not possible, the processing section 1d discards new first data even though the new first data is input from the sensor 2. The communication section 1e starts transmission of the second data stored in the second memory 1b and the first data stored in the third memory 1c to the information processing apparatus 3.

The power control section 1f receives the input of the predetermined operation by the user and causes the power of the third memory 1c and the communication section 1e to turn OFF, at a time point T3. The power control section 1f causes the power of the first memory 1a to turn ON. The processing section 1d may hold the first data input from the sensor 2, by using the first memory 1a. The processing section 1d starts generation of the second data based on the first data which has been stored in the first memory 1a.

In this manner, control is performed by the power control section 1f so as to cause the power of the first memory 1a and the communication section 1e not to simultaneously turn ON. Thus, leakage of the first data stored in the first memory 1a by an unauthorized access is suppressed. Specific descriptions are as follows.

Firstly, communication using the communication section 1e is not possible during a period when the first data is stored in the first memory 1a. Therefore, an access to the transmission apparatus 1 from the outside thereof is also not possible, and the leakage of the first data stored in the first memory 1a is suppressed.

Secondly, an access to the first memory 1a is not possible during a period when the communication section 1e transmits the second data. Therefore, even if an unauthorized access to the transmission apparatus 1 occurs, an access to the first memory 1a is not possible and the leakage of the first data is suppressed. Since the first memory 1a is set to be a volatile memory, if the power thereof turns OFF, the first data is deleted from the first memory 1a. Thus, it is possible to more reduce a probability of the leakage of the first data.

Thirdly, when abnormality occurs, first data which is capable of being transmitted by the communication section 1e is limited to data stored in the third memory 1c among pieces of first data which are sequentially input from the sensor 2. Therefore, it is possible to limit the quantity of first data transmitted by the communication section 1e to the minimum quantity desired for surveillance, when abnormality occurs. Meanwhile, the power of the first memory 1a is also in the OFF state during a period when the power of the communication section 1e is in the ON state, when the abnormality occurs. Thus, a situation in which new first data input from the sensor 2 is input to the third memory 1c also does not occur. In this manner, even though the unauthorized access to the transmission apparatus 1 occurs when abnormality occurs, it is possible to suppress leakage of pieces of information relating to a period other than a time when the abnormality occurs.

The power control section 1f may cause the power of the sensor 2 and the processing section 1d to turn ON and OFF along with the first memory 1a. For example, the power control section 1f may cause the power of the sensor 2 to turn ON when causing the power of the first memory 1a to turn ON. The power control section 1f may cause the power of the sensor 2 to turn OFF when causing the power of the first memory 1a to turn OFF. Thus, when the power of the communication section 1e is in the ON state, sensing by the sensor 2 is suspended. Therefore, it is possible to further reduce the risk of the leakage of the first data by an unauthorized access.

The power control section 1f may cause the power of the processing section 1d to turn ON when causing the power of the first memory 1a to turn ON, and may cause the power of the processing section 1d to turn OFF when causing the power of the first memory 1a to turn OFF. Thus, when the power of the communication section 1e is in the ON state, acquiring of the first data from the sensor 2 by the processing section 1d is suspended. Therefore, it is possible to further reduce the risk of the leakage of the first data by an unauthorized access.

Further, the power control section 1f may cause the power of both the sensor 2 and the processing section 1d to turn ON when causing the power of the first memory 1a to turn ON, and may cause the power of both the sensor 2 and the processing section 1d to turn OFF when causing the power of the first memory 1a to turn OFF. Thus, when the power of the communication section 1e is in the ON state, both sensing by the sensor 2 and acquiring of data from the sensor 2 by the processing section 1d are suspended. Therefore, it is possible to further reduce the risk of the leakage of the first data by an unauthorized access.

The function of the transmission apparatus 1 will be more specifically described below by using an example in which the transmission apparatus 1 is applied to a connected home system.

### Second Embodiment

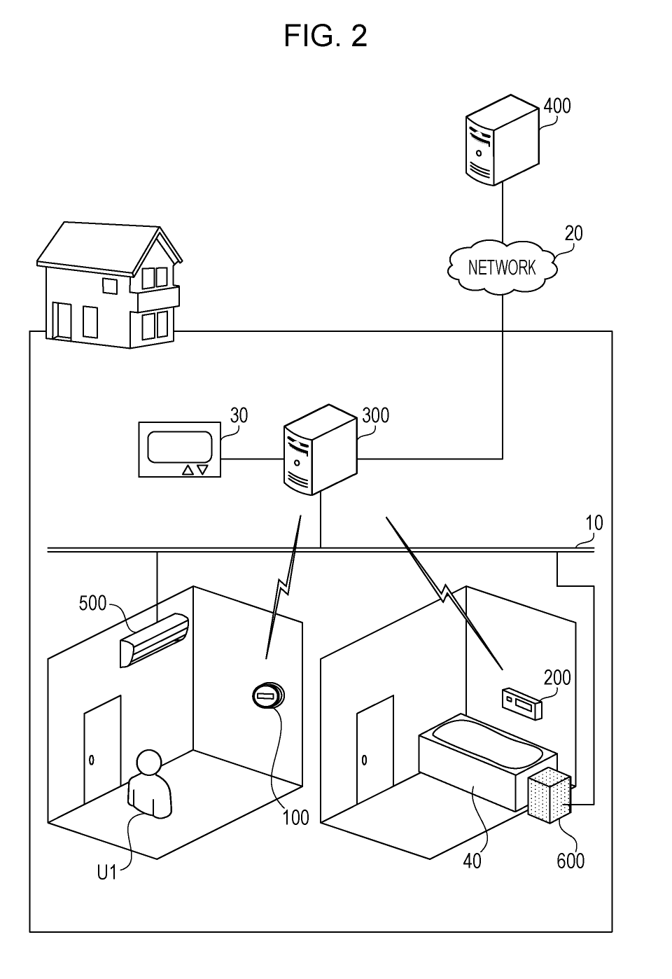

FIG. 2 is a diagram illustrating an example of a connected home system according to a second embodiment. The connected home system in the second embodiment is an information processing system in which an electronic device provided in a house in which a user U1 lives is remotely controlled in accordance with a situation of the user U1. The connected home system in the second embodiment includes sensor devices 100 and 200, a home server 300, a central server 400, and household electric appliances 500 and 600.

The home server 300 and the household electric appliances 500 and 600 are connected to a network 10. The network 10 is, for example, a local area network (LAN) provided in a house. The home server 300 and the central server 400 are connected to a network 20. The network 20 is, for example, the Internet or a wide area network (WAN).

The sensor devices 100 and 200 are devices for sensing, which are provided in habitable rooms in the house. The sensor devices 100 and 200 include a sensor function and a data transmission function. The sensor devices 100 and 200 may communicate with the home server 300 in a wireless manner. As a technique of wireless communication, for example, Bluetooth (registered trademark) or Bluetooth low energy (LE) may be used.

For example, the sensor device 100 is provided in a living room. Sensor data generated by the sensor device 100 is used for controlling an operation of the household electric appliance 500 provided in the living room. The sensor device 200 is provided in a bathroom. Sensor data generated by the sensor device 200 is used for controlling an operation of the household electric appliance 600 provided on the outside of the bathroom.

Here, the sensor devices 100 and 200 generate local context data based on the sensor data. The local context data is data which is used by the central server 400 in order to determine control details of an electronic device in a house. The local context data is data having a size which is smaller than that of the sensor data. The size of the local context data is, for example, about 8 bits or 16 bits. The sensor devices 100 and 200 transmit the local context data to the home server 300.

The sensor data is an example of the first data in the first embodiment. The local context data is an example of the second data in the first embodiment. The home server 300 is a server computer installed in a house. The home server 300 receives local context data from the sensor devices 100 and 200. The home server 300 adds user information and the like to the received local context data, and transmits the resultant to the central server 400.

The home server 300 receives global context data from the central server 400. The global context data is data which is generated by the central server 400, in a response to the local context data. The global context data is information corresponding to control details of an electronic device in a house. The home server 300 controls displayed contents of a monitor 30 or the operations of the household electric appliances 500 and 600, based on the global context data. Here, the monitor 30 is a display device installed in the house. As the monitor 30, for example, a liquid crystal display or the like may be used. The user U1 may confirm contents displayed in the monitor 30 and recognize an operation status of the household electric appliance 500 or the household electric appliance 600.

The central server 400 is a server computer used by a manager of the system. The central server 400 is provided in facilities or the like of a business operator who provides a service (also including health care, security, and the like) relating to a connected home. The central server 400 generates global context data based on local context data and transmits the generated global context data to the home server 300. Here, in the connected home system in the second embodiment, the local context data is converted into the global context data on the central server 400 side in which a secure environment is ensured, and the global context data is provided for the home server 300. Consequently, a way of controlling an electronic device in the house by using the local context data is not able to be easily supposed only by using the local context data.

The household electric appliances 500 and 600 are electronic devices installed in the house. The household electric appliance 500 is an air conditioner, for example. The household electric appliance 500 adjusts the temperature or the humidity of the living room. The household electric appliance 600 is a water heater, for example. The household electric appliance 600 adjusts the quantity of water stored in a bathtub 40 provided in the bathroom or adjusts the temperature of hot water. The household electric appliances 500 and 600 illustrated in FIG. 2 are just an example. Various electronic devices (for example, illumination equipment, floor heating, ventilation, refrigerator, electric shutter, electronic lock, and electromagnetic cooker) other than the above examples are considered as a control target of the connected home system.

The home server 300 is an example of the information processing apparatus 3 in the first embodiment. It may be considered that the central server 400 is an example of the information processing apparatus 3 in the first embodiment (because it is considered that the central server 400 indirectly controls the operations of the household electric appliances 500 and 600 through the home server 300).

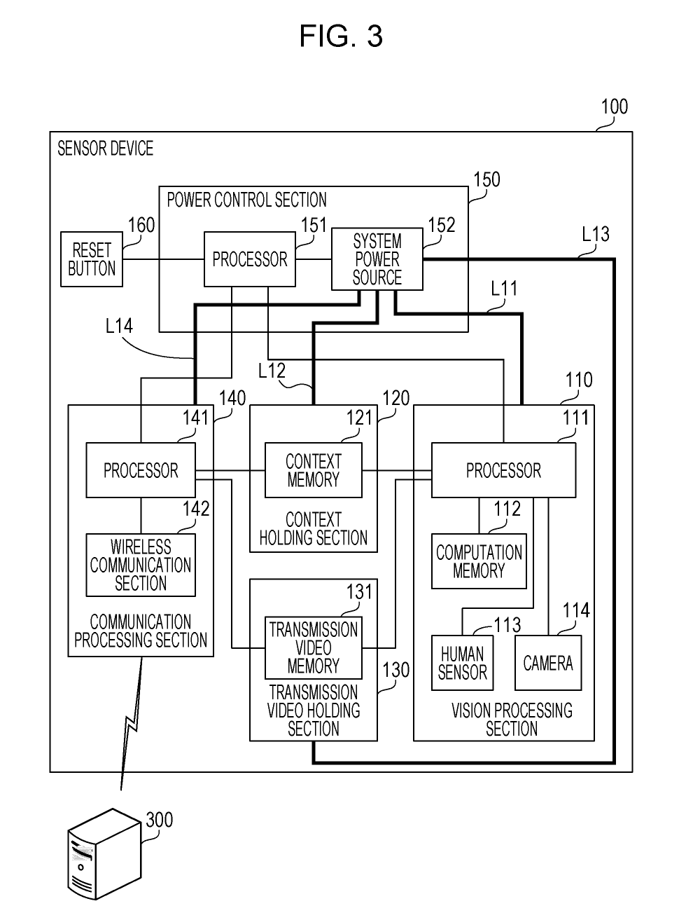

FIG. 3 is a diagram illustrating a hardware example of the sensor device in the second embodiment. The sensor device 100 includes a vision processing section 110, a context holding section 120, a transmission video holding section 130, a communication processing section 140, a power control section 150, and a reset button 160.

The vision processing section 110 is hardware that performs vision processing. The vision processing means processing of analyzing sensor data and acquiring local context data. The sensor data is image data (referred to as video data) of a video generated by an image sensor. The sensor data may be audio data generated by a microphone, heat distribution data detected by a temperature sensor, and the like. The vision processing section 110 includes a processor 111, a computation memory 112, a human sensor 113, and a camera 114.

The processor 111 is a computing device that controls information processing of the vision processing section 110. The processor 111 is, for example, a CPU, a DSP, an ASIC, or a FPGA. The processor 111 may be an assembly of two or more components of a CPU, a DSP, an ASIC, a FPGA, and the like.

The processor 111 acquires video data generated by the camera 114 and stores the acquired video data in the computation memory 112. The processor 111 performs predetermined computation processing based on the video data which has been stored in the computation memory 112. The processor 111 generates local context data as a result of the computation processing. The processor 111 outputs the generated local context data to the context holding section 120.

The processor 111 also detects abnormality (abnormality of the user U1, abnormality of the household electric appliances 500 and 600, and the like) occurring in a house, based on the generated local context data. If the processor 111 detects an occurrence of the abnormality, the processor 111 notifies the power control section 150 that the occurrence of the abnormality is detected. If the power of the transmission video holding section 130 is caused to turn ON by the power control section 150 in response to the notification, the processor 111 stores the video data (stored in the computation memory 112) acquired by the camera 114, in the transmission video holding section 130.

The computation memory 112 is a volatile storage device that stores data used in processing of the processor 111. For example, an SRAM may be used as the computation memory 112. Data acquired by the human sensor 113 or the camera 114 is firstly stored in the computation memory 112. The computation memory 112 has memory capacity which is capable of storing video data of about several frames.

The human sensor 113 detects the presence of the user U1 in the living room by using an infrared ray, and outputs a detection result to the processor 111. The camera 114 is an imaging device mounted in the image sensor. The image sensor may also be referred to as an imaging device. The camera 114 captures an image of the inside of the living room by using visible light, in accordance with an instruction of the processor 111. The camera 114 generates video data by using an image sensor, and outputs the generated video data to the processor 111. For example, the processor 111 may perform control in which capturing by the camera 114 is performed in a case where the user U1 is detected by the human sensor 113, and the capturing by the camera 114 is not performed in a case where the user U1 is not detected by the human sensor 113.

The context holding section 120 is a context data buffer provided between the vision processing section 110 and the communication processing section 140. The context holding section 120 includes a context memory 121. The context holding section 120 stores local context data output by the vision processing section 110, in the context memory 121. The context holding section 120 outputs local context data stored in the context memory 121 to the communication processing section 140.

The context memory 121 is a buffer memory for storing local context data. The context memory 121 may have memory capacity which is capable of storing at least local context data (for example, if the size of local context data is 16 bits, the size of the context memory 121 is set to be also about 16 bits).

The transmission video holding section 130 is a video data buffer provided between the vision processing section 110 and the communication processing section 140. The transmission video holding section 130 is normally in a state of power OFF. When the vision processing section 110 detects abnormality, the power of the transmission video holding section 130 is caused to turn ON by the power control section 150.

The transmission video holding section 130 includes a transmission video memory 131. The transmission video memory 131 is a volatile memory and is an SRAM, for example. The transmission video holding section 130 stores video data output by the vision processing section 110, in the transmission video memory 131. The transmission video holding section 130 outputs video data stored in the transmission video memory 131 to the communication processing section 140.

The transmission video memory 131 is a buffer memory for storing video data. The transmission video memory 131 may have memory capacity corresponding to the size (size determined depending on a period when a video is acquired) of a video transmitted to the home server 300 when abnormality occurs. For example, if a video for n seconds (n is a positive real number) is acquired and transmitted to the home server 300 when abnormality occurs, the transmission video memory 131 may have memory capacity which is capable of storing video data which has a size of at least n seconds.

The communication processing section 140 is hardware that performs data communication with the home server 300. The communication processing section 140 includes a processor 141 and a wireless communication section 142. The processor 141 is realized, for example, by a CPU, a DSP, an ASIC, a FPGA, or the like. The processor 141 may be an assembly of two or more components of a CPU, a DSP, an ASIC, a FPGA, and the like. The processor 141 transmits local context data acquired from the context holding section 120, to the home server 300 through the wireless communication section 142. The processor 141 transmits video data acquired from the transmission video holding section 130, to the home server 300 through the wireless communication section 142.

The wireless communication section 142 is a wireless communication interface (for example, interface of Bluetooth) that communicates with the home server 300 in a wireless manner. The power control section 150 is hardware that supplies power to each of the vision processing section 110, the context holding section 120, the transmission video holding section 130, and the communication processing section 140. A power line L11 is a line for supplying power to the vision processing section 110. A power line L12 is a line for supplying power to the context holding section 120. A power line L13 is a line for supplying power to the transmission video holding section 130. A power line L14 is a line for supplying power to the communication processing section 140.

The power control section 150 includes a processor 151 and a system power source 152. The processor 151 is realized by a FPGA, an ASIC, or the like. The processor 151 communicates with the processors 111 and 141 via an internal bus so as to control ON and OFF of the power of the vision processing section 110, the transmission video holding section 130, and the communication processing section 140 (details will be described later).

The system power source 152 is a power source of the sensor device 100. The system power source 152 obtains DC power from AC power supplied from a commercial power supply, and supplies the DC power to the vision processing section 110, the context holding section 120, the transmission video holding section 130, and the communication processing section 140. The system power source 152 may be a battery. The context holding section 120 and the power control section 150 are generally in a state of power ON.

The reset button 160 is an operation section that receives a pressing operation by a user. The reset button 160 outputs an input signal by the pressing operation, to the processor 151. The processor 151 receives the input signal after the abnormality occurs, and thus restarts surveillance for the normal time, which is performed by using the sensor device 100.

Here, the vision processing section 110 is an example of the processing section 1d in the first embodiment. The communication processing section 140 is an example of the communication section 1e in the first embodiment. The power control section 150 is an example of the power control section 1f in the first embodiment.

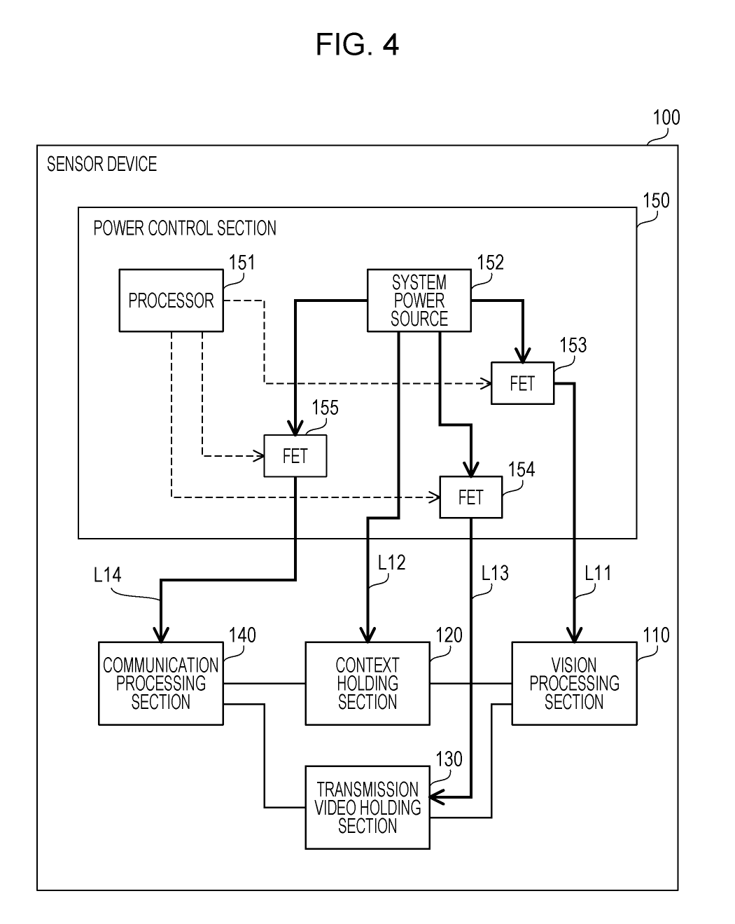

FIG. 4 is a diagram illustrating an example of the power control section in the second embodiment. The power control section 150 includes field effect transistors (FETs) 153, 154, and 155. In FIG. 4, connections of the power lines L11, L12, L13, L14 using the FETs 153, 154, and 155 are illustrated. In FIG. 4, illustrations of communication signal lines between the power control section 150, and the vision processing section 110, the context holding section 120, and the communication processing section 140 are omitted.

The FET 153 is provided on the power line L11. The FET 154 is provided on the power line L13. The FET 155 is provided on the power line L14. A power-ON signal or a power-OFF signal from the processor 151 is input to the FETs 153, 154, and 155. The processor 151 individually inputs the power-ON signal or the power-OFF signal to each of the FETs 153, 154, and 155.

If the power-ON signal is input to the FET 153, power is supplied to the vision processing section 110 from the system power source 152 on the power line L11. Thus, the power of the vision processing section 110 turns ON. Power ON of the vision processing section 110 means power ON of the processor 111, the computation memory 112, the human sensor 113, and the camera 114 including the image sensor. If the power-OFF signal is input to the FET 153, the power line L11 becomes in a state of being cut off. Thus, power supply from the system power source 152 to the vision processing section 110 is interrupted. Thus, the power of the vision processing section 110 turns OFF. Power OFF of the vision processing section 110 means power OFF of the processor 111, the computation memory 112, the human sensor 113, and the camera 114 including the image sensor.

If the power-ON signal is input to the FET 154, power is supplied to the transmission video holding section 130 from the system power source 152 through the power line L13. Thus, the power of the transmission video holding section 130 turns ON. Power ON of the transmission video holding section 130 means power ON of the transmission video memory 131. If the power-OFF signal is input to the FET 154, the power line L13 becomes in a state of being cut off. Thus, power supply from the system power source 152 to the transmission video holding section 130 is interrupted. Thus, the power of the transmission video holding section 130 turns OFF. Power OFF of the transmission video holding section 130 means power OFF of the transmission video memory 131.

If the power-ON signal is input to the FET 155, power is supplied to the communication processing section 140 from the system power source 152 through the power line L14. Thus, the power of the communication processing section 140 turns ON. If the power-OFF signal is input to the FET 155, the power line L14 becomes in a state of being cut off. Thus, power supply from the system power source 152 to the communication processing section 140 is interrupted. Thus, the power of the communication processing section 140 turns OFF.

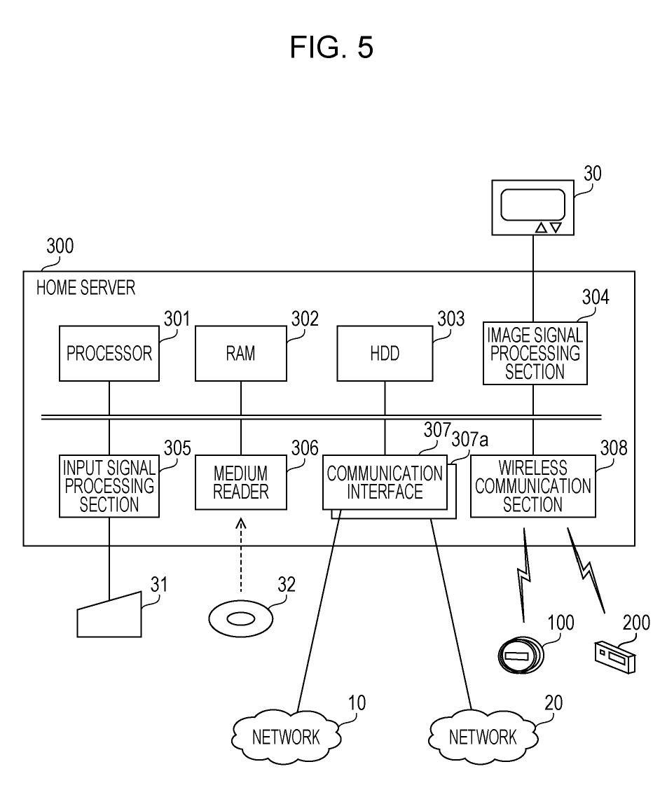

Power is generally supplied to the context holding section 120 by the system power source 152. That is, the context holding section 120 is generally in a state of power ON. FIG. 5 is a diagram illustrating a hardware example of the home server in the second embodiment,

The home server 300 includes a processor 301, a random-access memory (RAM) 302, a hard disk drive (HDD) 303, an image signal processing section 304, an input signal processing section 305, a medium reader 306, communication interfaces 307 and 307a, and a wireless communication section 308. The sections are connected to a bus in the home server 300. The central server 400 may also be realized by using hardware which is similar to that of the home server 300.

The processor 301 controls information processing of the home server 300. The processor 301 may be a multiprocessor. The processor 301 is, for example, a CPU, a DSP, an ASIC, or a FPGA. The processor 301 may be an assembly of two or more components of a CPU, a DSP, an ASIC, a FPGA, and the like.

The RAM 302 is the main storage device of the home server 300. The RAM 302 temporarily stores at least a portion of a program of an operating system (OS) or an application program which is executed by the processor 301. The RAM 302 stores various types of data which are used in processing of the processor 301.

The HDD 303 is an auxiliary storage device of the home server 300. The HDD 303 magnetically writes and reads data in and from a built-in magnetic disk. The HDD 303 stores the program of the OS, the application program, and various types of data. The home server 300 may include other various auxiliary storage devices such as a flash memory and a solid-state drive (SSD), or may include a plurality of auxiliary storage devices.

The image signal processing section 304 displays an image in the monitor 30 connected to the home server 300, in accordance with a command from the processor 301. A liquid crystal display or the like may be used as the monitor 30.

The input signal processing section 305 acquires an input signal from an input device 31 connected to the home server 300, and outputs the acquired input signal to the processor 301. For example, a pointing device such as a mouse or a touch panel, a keyboard, and the like may be used as the input device 31.

The medium reader 306 is a device that reads out a program or data which has been recorded in a recording medium 32. For example, a magnetic disk such as a flexible disk (FD) or a HDD, an optical disk such as a compact disc (CD) or a digital versatile disc (DVD), or a magneto-optical disk (MO) may be used as the recording medium 32. For example, a non-volatile semiconductor memory such as a flash memory card may also be used as the recording medium 32. The medium reader 306 stores a program or data which has been read out from the recording medium 32, in the RAM 302 or the HDD 303 in accordance with a command from the processor 301, for example.

The communication interface 307 is connected to the network 10 and communicates with the household electric appliances 500 and 600 via the network 10. The communication interface 307 may be a wired communication interface or a wireless communication interface.

The communication interface 307a is connected to the network 20, and communicates with the central server 400 via the network 20. The communication interface 307a may be a wired communication interface or a wireless communication interface.

The wireless communication section 308 is a wireless communication interface that communicates with the sensor devices 100 and 200 in a wireless manner. As described above, for example, Bluetooth may be used as a wireless communication technique.

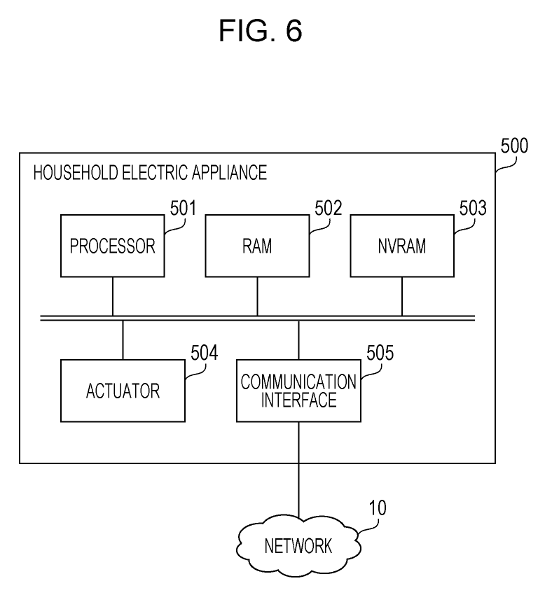

FIG. 6 is a diagram illustrating a hardware example of the household electric appliance in the household electric appliance in the second embodiment. The household electric appliance 500 includes a processor 501, a RAM 502, a non-volatile RAM (NVRAM) 503, an actuator 504, and a communication interface 505.

The processor 501 controls information processing of the household electric appliance 500. The processor 501 may be a multiprocessor. The processor 501 is, for example, a CPU, a DSP, an ASIC, or a FPGA. The processor 501 may be an assembly of two or more components of a CPU, a DSP, an ASIC, a FPGA, and the like.

The RAM 502 is the main storage device of the household electric appliance 500. The RAM 502 temporarily stores at least a portion of a program of a firmware or an application program which is executed by the processor 501. The RAM 502 stores various types of data which are used in processing of the processor 501.

The NVRAM 503 is an auxiliary storage device of the household electric appliance 500. The NVRAM 503 stores the program of the firmware, the application program, and various types of data.

The actuator 504 is a driving device of the household electric appliance 500. For example, if the household electric appliance 500 is an air conditioner, the actuator 504 is used for driving a damper (that adjusts air volume), changing a direction of an air flow, or the like.

The communication interface 505 communicates with the home server 300 via the network 10. The communication interface 505 may be a wired communication interface or a wireless communication interface.

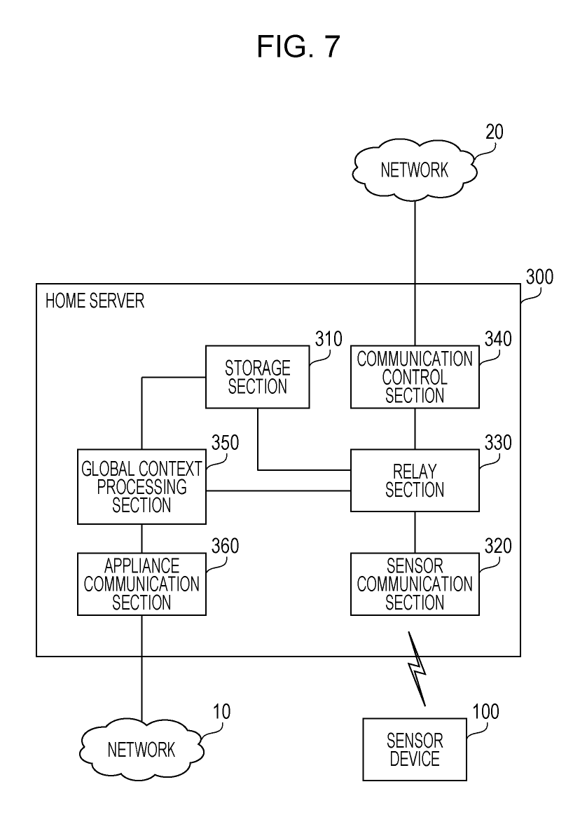

FIG. 7 is a diagram illustrating a function example of the home server in the second embodiment. The home server 300 includes a storage section 310, a sensor communication section 320, a relay section 330, a communication control section 340, a global context processing section 350, and an appliance communication section 360. For example, the storage section 310 is realized by using a storage area which has been secured in the RAM 302 or the HDD 303. The sensor communication section 320, the relay section 330, the communication control section 340, the global context processing section 350, and the appliance communication section 360 are realized by causing the processor 301 to execute a program stored in the RAM 302.

The storage section 310 stores data used in processing of the relay section 330 or the global context processing section 350. Specifically, the storage section 310 stores user information (for example, information regarding an account of a user) of the user U1 or a table for converting global context data into commands for the household electric appliances 500 and 600.

The sensor communication section 320 communicates with the sensor devices 100 and 200 (in FIG. 7, illustration of the sensor device 200 is omitted). The sensor communication section 320 receives local context data from the sensor devices 100 and 200. The sensor communication section 320 receives sensor data (for example, video data) from a sensor device (for example, sensor device 100) that has detected abnormality, when the abnormality has occurred.

The relay section 330 performs relay of data between the sections of the home server 300. The relay section 330 adds user information stored in the storage section 310 to local context data received by the sensor communication section 320, so as to generate communication data for the central server 400. The relay section 330 transmits the generated communication data to the central server 400 via the communication control section 340. The relay section 330 adds user information to video data received by the sensor communication section 320, and transmits the resultant to the central server 400 via the communication control section 340.

If the relay section 330 receives global context data from the central server 400, the relay section 330 transfers the received global context data to the global context processing section 350.

The communication control section 340 communicates with the central server 400 via the network 20. The communication control section 340 transmits the communication data generated by the relay section 330 to the central server 400, when abnormality occurs. The communication data includes local context data and user information of the user U1. The communication control section 340 receives global context data from the central server 400.

The communication control section 340 transmits video data and user information which have been acquired from the relay section 330, to the central server 400. The global context processing section 350 converts the global context data to commands for the household electric appliances 500 and 600, with reference to a table for command conversion, which is stored in the storage section 310.

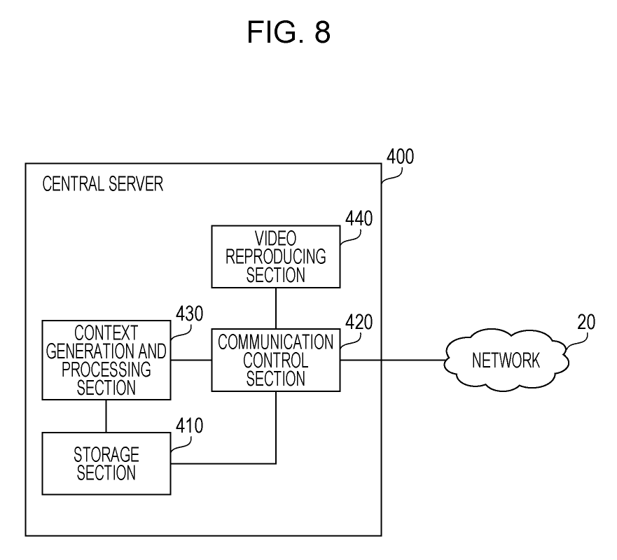

The appliance communication section 360 receives commands for the household electric appliances 500 and 600, from the global context processing section 350, and then transmits the received commands to the household electric appliances 500 and 600. FIG. 8 is a diagram illustrating a function example of the central server in the second embodiment. The central server 400 includes a storage section 410, a communication control section 420, a context generation and processing section 430, and a video reproducing section 440. For example, the storage section 410 is realized by using a storage area which has been secured in the RAM or the HDD provided in the central server 400. The communication control section 420, the context generation and processing section 430, and the video reproducing section 440 are realized by causing the processor in the central server 400 to execute a program stored in the RAM provided in the central server 400.

The storage section 410 stores a context conversion table. The context conversion table is a table used for converting local context data into global context data. The context conversion table is also referred to as a list of contents permitted as the local context data. The context conversion table is provided for each user. For example, the storage section 410 stores a plurality of context conversion tables for a plurality of users, respectively. Each of the plurality of context conversion tables is associated with information of an account of each user.

The communication control section 420 communicates with the home server 300 via the network 20. The communication control section 420 receives communication data including local context data, from the home server 300. The communication control section 420 transmits global context data generated by the context generation and processing section 430, to the home server 300.

Further, the communication control section 420 receives video data having user information added thereto, from the home server 300. The context generation and processing section generates global context data in response to the received local context data, based on the context conversion table stored in the storage section 410. Specifically, the context generation and processing section 430 selects a context conversion table corresponding to the user among a plurality of context conversion tables stored in the storage section 410, based on user information included in communication data which is received at this time. The context generation and processing section 430 extracts global context data corresponding to local context data which is included in the communication data, with respect to the selected context conversion table. The context generation and processing section 430 transfers the extracted global context data to the communication control section 420.

The video reproducing section 440 reproduces video data received by the communication control section 420, and displays a video along with the user information added to the video data by using the display connected to the central server 400.

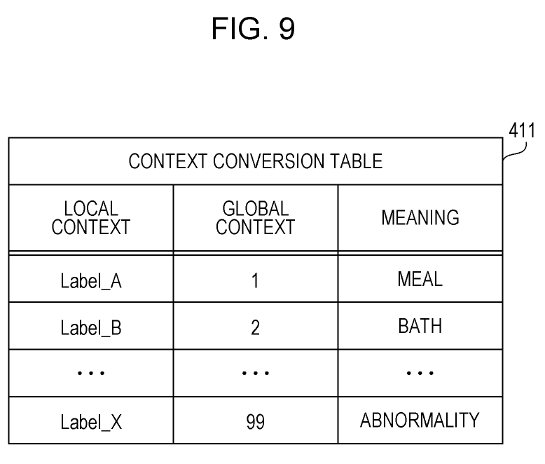

FIG. 9 is a diagram illustrating an example of the context conversion table in the second embodiment. The context conversion table 411 is previously stored in the storage section 410. The context conversion table 411 includes items of a local context, a global context, and the meaning.

Contents of local context data are registered in the item of the local context. Contents of global context data are registered in the item of the global context. The meaning represented by the global context data is registered by the item of the meaning. The item of the meaning is provided for convenience in order to easily understand the contents of the global context data. Thus, the item of the meaning may be omitted from the context conversion table 411.

For example, a record of “Label_A” as a local context, “1” as a global context, and “meal” as the meaning is registered in the context conversion table 411. This represents that global context data is set to be “1” in a case where local context data is “Label_A”. The global context data being “1” represents that the global context data is data indicating that a user has a meal.

In the context conversion table 411, global context data is associated with another piece of local context data in a similar manner. A record of “Label_X” as a local context, “99” as a global context, and “abnormality” as the meaning is also registered in the context conversion table 411. This record represents a point that local context data of “Label_X” means an occurrence of abnormality, and a point that global context data is set to be “99” in correspondence with the local context data of “Label_X”.

Next, a specific example of power control performed by the power control section 150 will be described. Regarding the power control performed by the power control section 150, three patterns (referred to as Patterns 1, 2, and 3) are considered. Specific control details will be described below in an order of Patterns 1, 2, and 3.

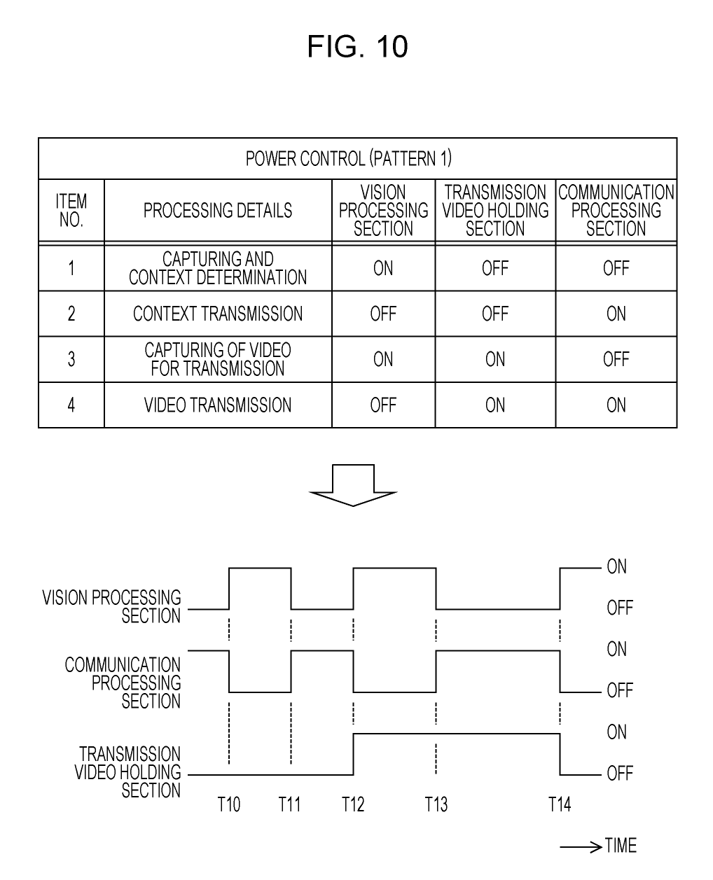

FIG. 10 is a diagram illustrating an example of the power control (Pattern 1) in the second embodiment. A table in FIG. 10 represents a state of power ON and power OFF of the vision processing section 110, the transmission video holding section 130, and the communication processing section 140, for each of processing details by the sensor device 100. In FIG. 10, power ON is represented by “ON” and power OFF is represented by “OFF”.

A processing detail for an item number of “1” is “capturing and context determination”. “Capturing and context determination” is performed by the vision processing section 110. In capturing processing, video data is acquired by the camera 114. Context determination processing is processing of determining local context data based on the acquired video data and storing the local context data in the context holding section 120. In the “capturing and context determination” processing, the power of the vision processing section 110 is in the ON state, the power of the transmission video holding section 130 is in the OFF state, and the power of the communication processing section 140 is in the OFF state.

A processing detail for an item number of “2” is “context transmission”. Context transmission processing is performed by the communication processing section 140. The context transmission processing is processing of transmitting local context data stored in the context holding section 120 to the home server 300. In the context transmission processing, the power of the vision processing section 110 is in the OFF state, the power of the transmission video holding section 130 is in the OFF state, and the power of the communication processing section 140 is in the ON state.

A processing detail for an item number of “3” is “capturing of video for transmission”. Capturing processing of video for transmission” is performed by the vision processing section 110. The capturing processing of video for transmission is processing of duplicating video data which has been generated by the camera 114 and stored in the computation memory 112, and storing the duplicated data in the transmission video memory 131. In the capturing processing of video for transmission, the power of the vision processing section 110 is in the ON state, the power of the transmission video holding section 130 is in the ON state, and the power of the communication processing section 140 is in the OFF state.

A processing detail for an item number of “4” is “video transmission”. Video transmission processing is performed by the communication processing section 140. The video transmission processing is processing of transmitting video data stored in the transmission video memory 131, to the home server 300. In the video transmission processing, the power of the vision processing section 110 is in the OFF state, the power of the transmission video holding section 130 is in the ON state, and the power of the communication processing section 140 is in the ON state.

FIG. 10 also illustrates an example of time series when the power control section 150 controls power ON and power OFF of the vision processing section 110, the communication processing section 140, and the transmission video holding section 130. Time points T10, T11, T12, T13, and T14 are timings when the power of any of the vision processing section 110, the communication processing section 140, and the transmission video holding section 130 is switched from the ON state to the OFF state, or is switched from the OFF state to the ON state. High indicates power ON. Low indicates power OFF. A direction from the left side toward the right side in FIG. 10 is a forward direction of time series.

Just before the time point T10, the power of the vision processing section 110 is in the OFF state, the power of the communication processing section 140 is in the ON state, and the power of the transmission video holding section 130 is in the OFF state. A time zone just before the time point T10 is a time zone of the context transmission processing.

At the time point T10, the power control section 150 causes the power of the communication processing section 140 to turn OFF and causes the power of the vision processing section 110 to turn ON. The power of the transmission video holding section 130 is maintained to be in the OFF state. A time zone from the time point T10 to the time point T11 is a time zone for the “capturing and context determination” processing. Here, it is assumed that the vision processing section 110 detects an occurrence of abnormality as a result of the context determination processing. For example, the vision processing section 110 generates local context data of “Label_X” and stores the generated local context data in the context memory 121. The vision processing section 110 notifies the power control section 150 to detect the occurrence of abnormality.

At the time point T11, the power control section 150 causes the power of the vision processing section 110 to turn OFF and causes the power of the communication processing section 140 to turn ON. The power of the transmission video holding section 130 is maintained to be in the OFF state. A time zone from the time point T11 to the time point T12 is a time zone for the context transmission processing. The communication processing section 140 transmits the local context data of “Label_X” stored in the context memory 121, to the home server 300.

At the time point T12, the power control section 150 causes the power of the communication processing section 140 to turn OFF and causes the power of the vision processing section 110 and the transmission video holding section 130 to turn ON. A time zone from the time point T12 to the time point T13 is a time zone for the capturing processing of video for transmission. Specifically, the vision processing section 110 stores video data generated by the camera 114, in the computation memory 112. The vision processing section 110 duplicates the video data stored in the computation memory 112, and stores the duplicated data in the transmission video memory 131. The vision processing section 110 duplicates pieces of video data which have been sequentially stored in the computation memory 112, and stores the duplicated pieces of data in the transmission video memory 131 until the time point T13. An acquisition time n (=T13−T12) (seconds) of video data is predetermined as described above.

At the time point T13, the power control section 150 causes the power of the vision processing section 110 to turn OFF and causes the power of the communication processing section 140 to turn ON. The power of the transmission video holding section 130 is maintained to be in the ON state. A time zone from the time point T13 to the time point T14 is a time zone for the video transmission processing. Specifically, the communication processing section 140 transmits video data stored in the transmission video memory 131, to the home server 300. The power control section 150 restricts power ON of the vision processing section 110 until the reset button 160 is pressed after the time point T13 (that is, the power of the vision processing section 110 is maintained to be in the OFF state).

At the time point T14, the power control section 150 receives an operation of pressing the reset button 160. The power control section 150 causes the power of the communication processing section 140 and the transmission video holding section 130 to turn OFF and causes the power of the vision processing section 110 to turn ON. A time zone just after the time point T14 is a time zone for the “capturing and context determination” processing.

In the power control (Pattern 1), the power control section 150 causes the power of the vision processing section 110 and the communication processing section 140 to exclusively turn ON. That is, the power control section 150 sets the power of the communication processing section 140 to be in the OFF state during a period when the power of the vision processing section 110 is in the ON state. The power control section 150 sets the power of the vision processing section 110 to be in the OFF state during a period when the power of the communication processing section 140 is in the ON state.

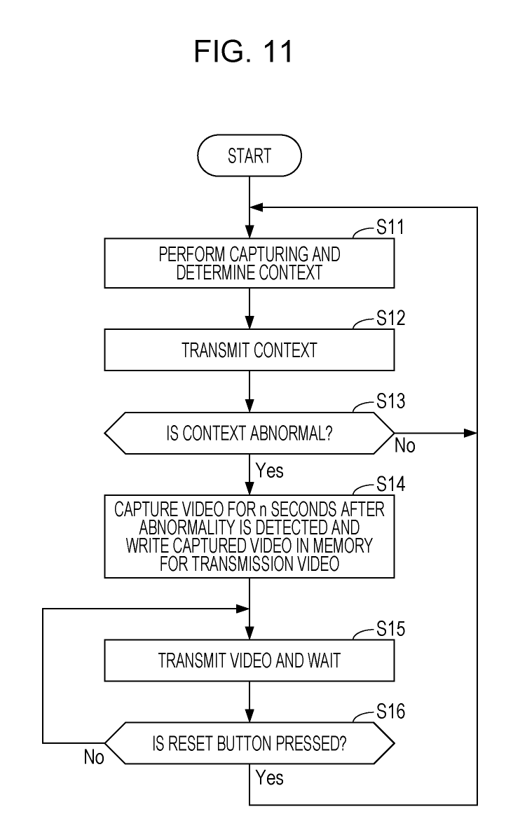

Next, an example of procedures of data transmission processing by the sensor device 100 in a case where the power control section 150 performs the power control (Pattern 1) will be described. FIG. 11 is a flowchart illustrating a transmission processing example in the power control (Pattern 1). Processes illustrated in FIG. 11 will be described below along the step number. Just before Step S11, the power of the vision processing section 110 is in the ON state, and the power of the transmission video holding section 130 and the communication processing section 140 is in the OFF state.

(S11) The vision processing section 110 captures a video by using the camera 114, and stores video data generated by capturing, in the computation memory 112. The vision processing section 110 determines a context (local context data) based on the video data stored in the computation memory 112. For example, the vision processing section 110 recognizes a user U1 from the video data, and generates local context data in accordance with the presence or absence of the user U1, an operation of the user U1, and the like. The vision processing section 110 stores the generated local context data in the context memory 121. The vision processing section 110 notifies power control section 150 of a determination result of the context. Here, the determination result indicates normality or abnormality. If the power control section 150 receives the notification, the power control section 150 causes the power of the vision processing section 110 to turn OFF and causes the power of the communication processing section 140 to turn ON.

(S12) The communication processing section 140 transmits the local context data stored in the context memory 121, to the home server 300.

(S13) The power control section 150 determines whether or not the determination result of the context of which the notification is performed from the vision processing section 110 in Step S11 indicates abnormality. In a case where the determination result indicates abnormality, the power control section 150 causes the power of the communication processing section 140 to turn OFF and causes the power of the vision processing section 110 and the transmission video holding section 130 to turn ON, and then causes the process to proceed to Step S14. In a case where the determination result does not indicate abnormality, the power control section 150 causes the power of the communication processing section 140 to turn OFF and causes the power of the vision processing section 110 to turn ON, and then causes the process to proceed to Step S11.

(S14) The vision processing section 110 captures a video for n seconds after abnormality is detected by using the camera 114. The vision processing section 110 performs buffering of video data generated by the capturing, in the computation memory 112 (may performs buffering by using an internal buffer of the processor 111). The vision processing section 110 duplicates video data stored in the computation memory 112, and writes the duplicated video data in the transmission video memory 131. As described above, the capacity of the computation memory 112 is set to be allowable to store video data for about several frames. Thus, the vision processing section 110 duplicates pieces of video data which have been sequentially acquired and stored in the computation memory 112, and thus stores video data for n seconds in the transmission video memory 131. If the vision processing section 110 completes acquisition of video data for n seconds, the vision processing section 110 notifies the power control section 150 of completion of acquisition of the video data. If the power control section 150 receives the notification, the power control section 150 causes the power of the vision processing section 110 to turn OFF and causes the power of the communication processing section 140 to turn ON

(S15) The communication processing section 140 transmits video data stored in the transmission video memory 131 to the home server 300. The communication processing section 140 notifies the power control section 150 of completion of transmission of video data. The power control section 150 waits until the reset button 160 is pressed.

(S16) The power control section 150 determines whether or not the reset button 160 is pressed. In a case where the reset button 160 is pressed, the power control section 150 causes the power of the transmission video holding section 130 and the communication processing section 140 to turn OFF, and causes the power of the vision processing section 110 to turn ON. Then, the process proceeds to Step S11. In a case where the reset button 160 is not pressed, the power control section 150 causes the process to proceed to Step S15 and waits for an operation of pressing the reset button 160.

In Step S15, the communication processing section 140 may automatically transmit video data just after the power of the communication processing section 140 turns ON, or after an instruction to desire a video is received by the home server 300. For example, a manager who uses the central server 400 may confirm the occurrence of abnormality based on local context data, and perform an instruction from the central server 400 to the home server 300 such that the home server 300 transmits a request for a video to the sensor device 100. The home server 300 transmits video data acquired from the sensor device 100, to the central server 400. If the transmission is performed, the manager can confirm video data just after the occurrence of abnormality, by the central server 400. The manager can consider proper measures (for example, emergency response and the like if it is recognized that the user U1 is seriously injured).

Alternatively, the home server 300 or the central server 400 may notify a terminal apparatus used by another user, of the occurrence of abnormality in accordance with local context data or global context data, and thus may cause this user to know the occurrence of abnormality by the terminal apparatus. In this case, this user may instruct the home server 300 to transmit a request for a video to the sensor device 100, by using the terminal apparatus. The home server 300 transmits video data acquired from the sensor device 100, to a terminal apparatus used by another user. If the transmission is performed, this user can confirm video data just after the occurrence of abnormality, by using the terminal apparatus. This user can consider proper measures (for example, emergency response and the like if it is recognized that the user U1 is seriously injured).

The communication processing section 140 may transmit video data stored in the transmission video memory 131 to the home server 300 every time a request for a video is received from the home server 300, even during a period when the communication processing section 140 waits for an operation of pressing the reset button 160, after transmission of video data is completed.

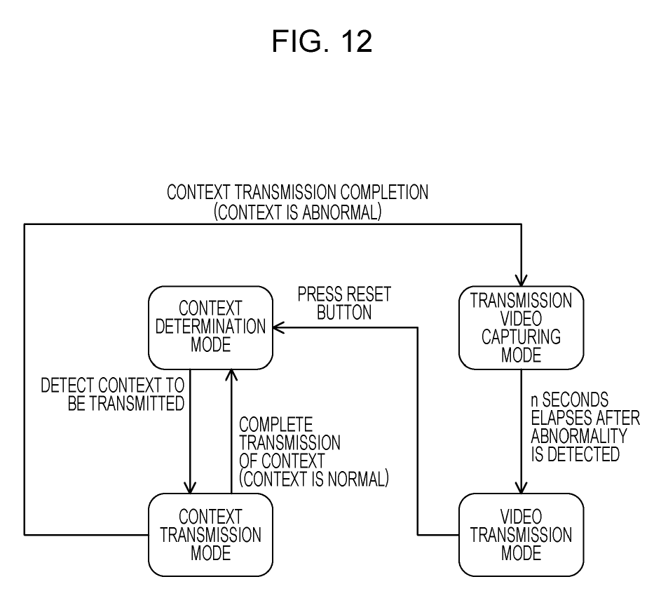

FIG. 12 is a diagram illustrating a state transition example of the sensor device in the power control (Pattern 1). Here, a state of the sensor device 100 when the sensor device 100 performs the “capturing and context determination” processing is referred to as a “context determination mode”. A state of the sensor device 100 when the sensor device 100 performs the context transmission processing is referred to as a “context transmission mode”. A state of the sensor device 100 when the sensor device 100 performs the transmission video capturing processing is referred to as a “transmission video capturing mode”. A state of the sensor device 100 when the sensor device 100 performs the video transmission processing is referred to as a “video transmission mode”.

In the context determination mode, if the sensor device 100 detects context data (local context data) to be transmitted, the sensor device 100 transitions to the context transmission mode. In the context transmission mode, in a case where transmission of local context data (context transmission) is completed and the local context data exhibits normality, the sensor device 100 transitions to the context determination mode.

In the context transmission mode, in a case where transmission of local context data (context transmission) is completed and the local context data exhibits abnormality, the sensor device 100 transitions to the transmission video capturing mode.

In the transmission video capturing mode, the sensor device 100 acquires video data. If n seconds elapses after abnormality occurs, the sensor device 100 transitions to the video transmission mode. In the video transmission mode, the sensor device 100 transmits the acquired video data. If the reset button 160 is pressed, the sensor device 100 transitions to the context determination mode.

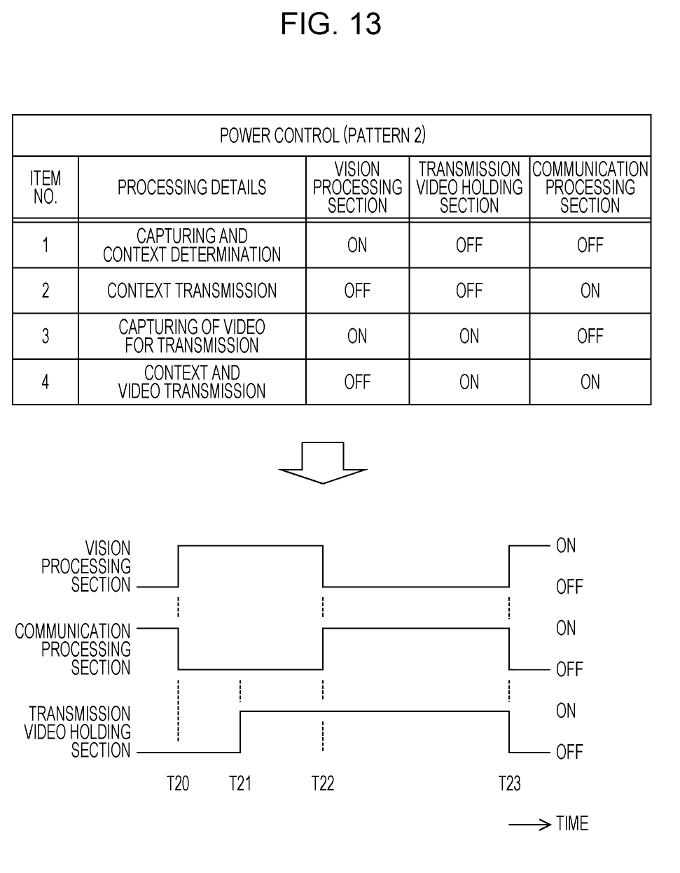

Next, power control (Pattern 2) performed by the power control section 150 will be described. FIG. 13 is a diagram illustrating an example of the power control (Pattern 2) in the second embodiment. Similar to FIG. 10, a table in FIG. 13 represents a state of power ON and power OFF of the vision processing section 110, the transmission video holding section 130, and the communication processing section 140, for each of processing details by the sensor device 100.

A processing detail for an item number of “1” is “capturing and context determination”. In the “capturing and context determination” processing, the power of the vision processing section 110 is in the ON state, the power of the transmission video holding section 130 is in the OFF state, and the power of the communication processing section 140 is in the OFF state.

A processing detail for an item number of “2” is “context transmission”. In the context transmission processing, the power of the vision processing section 110 is in the OFF state, the power of the transmission video holding section 130 is in the OFF state, and the power of the communication processing section 140 is in the ON state.

A processing detail for an item number of “3” is “capturing of video for transmission”. In the capturing processing of video for transmission, the power of the vision processing section 110 is in the ON state, the power of the transmission video holding section 130 is in the ON state, and the power of the communication processing section 140 is in the OFF state.

A processing detail for an item number of “4” is “context and video transmission”. The context and video transmission processing is performed by the communication processing section 140. The context and video transmission processing is processing of transmitting local context data stored in the context memory 121 and video data stored in the transmission video memory 131 to the home server 300. In the context and video transmission processing, the power of the vision processing section 110 is in the OFF state, the power of the transmission video holding section 130 is in the ON state, and the power of the communication processing section 140 is in the ON state.

FIG. 13 also illustrates an example of time series when the power control section 150 controls power ON and power OFF of the vision processing section 110, the communication processing section 140, and the transmission video holding section 130. Time points T20, T21, T22, and T23 are timings when the power of any of the vision processing section 110, the communication processing section 140, and the transmission video holding section 130 is switched from the ON state to the OFF state, or is switched from the OFF state to the ON state. High indicates power ON. Low indicates power OFF. A direction from the left side toward the right side in FIG. 13 is a forward direction of time series.

Just before the time point T20, the power of the vision processing section 110 is in the OFF state, the power of the communication processing section 140 is in the ON state, and the power of the transmission video holding section 130 is in the OFF state. A time zone just before the time point T20 is a time zone of the context transmission processing.

At the time point T20, the power control section 150 causes the power of the communication processing section 140 to turn OFF, and causes the power of the vision processing section 110 to turn ON. The power of the transmission video holding section 130 is maintained to be in the OFF state. A time zone from the time point T20 to the time point T21 is a time zone for the “capturing and context determination” processing. Here, it is assumed that the vision processing section 110 detects an occurrence of abnormality as a result of the context determination processing. For example, the vision processing section 110 generates local context data of “Label_X” and stores the generated local context data in the context memory 121. The vision processing section 110 notifies the power control section 150 to detect the occurrence of abnormality.

At the time point T21, the power control section 150 causes the power of the transmission video holding section 130 to turn ON. The power of the vision processing section 110 is maintained to be in the ON state. The power of the communication processing section 140 is maintained to be in the OFF state. A time zone from the time point T21 to the time point T22 is a time zone for the capturing processing of video for transmission. Specifically, the vision processing section 110 stores video data generated by the camera 114, in the computation memory 112. The vision processing section 110 duplicates the video data stored in the computation memory 112, and stores the duplicated data in the transmission video memory 131. The vision processing section 110 duplicates pieces of video data which have been sequentially stored in the computation memory 112 and stores the duplicated pieces of video data in the transmission video memory 131, until the time point T22. An acquisition time n (=T22−T21) (seconds) of video data is predetermined as described above.

At the time point T22, the power control section 150 causes the power of the vision processing section 110 to turn OFF, and causes the power of the communication processing section 140 to turn ON. The power of the transmission video holding section 130 is maintained to be in the ON state. A time zone from the time point T22 to the time point T23 is a time zone for the context and video transmission processing. Specifically, the communication processing section 140 transmits local context data stored in the context memory 121 and video data stored in the transmission video memory 131 to the home server 300. The power control section 150 restricts power ON of the vision processing section 110 until the reset button 160 is pressed after the time point T22.

At the time point T23, the power control section 150 receives an operation of pressing the reset button 160. The power control section 150 causes the power of the communication processing section 140 and the transmission video holding section 130 to turn OFF and causes the power of the vision processing section 110 to turn ON. A time zone just after the time point T23 is a time zone for the “capturing and context determination” processing.

In the power control (Pattern 2), the power control section 150 also causes the power of the vision processing section 110 and the communication processing section 140 to exclusively turn ON. That is, the power control section 150 sets the power of the communication processing section 140 to be in the OFF state during a period when the power of the vision processing section 110 is in the ON state. The power control section 150 sets the power of the vision processing section 110 to be in the OFF state during a period when the power of the communication processing section 140 is in the ON state.

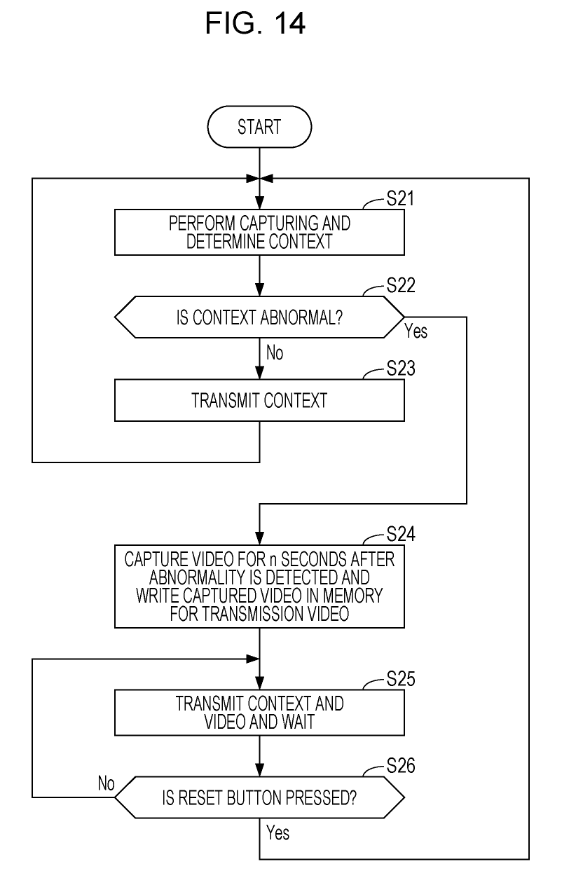

Next, an example of procedures of data transmission processing by the sensor device 100 in a case where the power control section 150 performs the power control (Pattern 2) will be described. FIG. 14 is a flowchart illustrating a transmission processing example of the power control (Pattern 2). Processes illustrated in FIG. 14 will be described below along the step number. Just before Step S21, the power of the vision processing section 110 is in the ON state, and the power of the transmission video holding section 130 and the communication processing section 140 is in the OFF state.

(S21) The vision processing section 110 captures a video by using the camera 114, and stores video data generated by capturing, in the computation memory 112. The vision processing section 110 determines a context (local context data) based on the video data stored in the computation memory 112. The vision processing section 110 stores the generated local context data in the context memory 121. The vision processing section 110 notifies power control section 150 of a determination result of the context.

(S22) The power control section 150 determines whether or not the determination result of the context of which the notification is performed from the vision processing section 110 in Step S21 indicates abnormality. In a case where the determination result indicates abnormality, the power control section 150 causes the power of the transmission video holding section 130 to turn ON, and then causes the process to proceed to Step S24. In a case where the determination result does not indicate abnormality, the power control section 150 causes the power of the vision processing section 110 to turn OFF and causes the power of the communication processing section 140 to turn ON, and then causes the process to proceed to Step S23.

(S23) The communication processing section 140 transmits local context data stored in the context memory 121 to the home server 300. If the transmission is completed, the communication processing section 140 notifies the power control section 150 of completion of the transmission. If the power control section 150 receives the notification of the completion of the transmission, the power control section 150 causes the power of the communication processing section 140 to turn OFF and causes the power of the vision processing section 110 to turn ON, and then causes the process to proceed to Step S21.

(S24) The vision processing section 110 captures a video for n seconds after abnormality is detected by using the camera 114. The vision processing section 110 performs buffering of video data generated by the capturing, in the computation memory 112. The vision processing section 110 duplicates video data stored in the computation memory 112, and writes the duplicated video data in the transmission video memory 131. If the vision processing section 110 completes acquisition of video data for n seconds, the vision processing section 110 notifies the power control section 150 of completion of acquisition of the video data. If the power control section 150 receives the notification, the power control section 150 causes the power of the vision processing section 110 to turn OFF and causes the power of the communication processing section 140 to turn ON.

(S25) The communication processing section 140 transmits local context data stored in the context memory 121 to the home server 300. The communication processing section 140 transmits video data stored in the transmission video memory 131 to the home server 300. The communication processing section 140 notifies the power control section 150 of completion of transmission of video data. The power control section 150 waits until the reset button 160 is pressed.

(S26) The power control section 150 determines whether or not the reset button 160 is pressed. In a case where the reset button 160 is pressed, the power control section 150 causes the power of the transmission video holding section 130 and the communication processing section 140 to turn OFF, and causes the power of the vision processing section 110 to turn ON. Then, the process proceeds to Step S21. In a case where the reset button 160 is not pressed, the power control section 150 causes the process to proceed to Step S25 and waits for an operation of pressing the reset button 160.

Similar to Step S15 in FIG. 11, in Step S25, the communication processing section 140 may automatically transmit video data just after the power of the communication processing section 140 turns ON, or after an instruction to desire a video is received by the home server 300. The communication processing section 140 may transmit video data stored in the transmission video memory 131 to the home server 300 every time a request for a video is received from the home server 300, even during a period when the communication processing section 140 waits for an operation of pressing the reset button 160, after transmission of video data is completed.

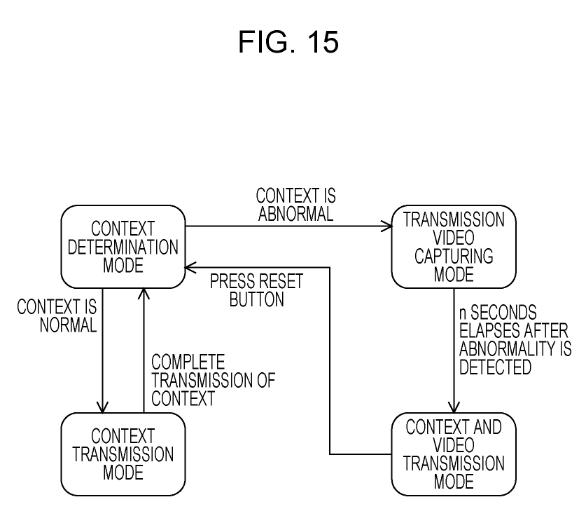

FIG. 15 is a diagram illustrating a state transition example of the sensor device in the power control (Pattern 2). Here, a state of the sensor device 100 when the sensor device 100 performs the context and video transmission processing is referred to as a “context and video transmission mode”.

In the context determination mode, the sensor device 100 detects context data (local context data) to be transmitted. In a case where the local context data exhibits normality, the sensor device 100 transitions to the context transmission mode. In a case where the local context data exhibits abnormality, the sensor device 100 transitions to the transmission video capturing mode.

In the context transmission mode, if transmission of local context data (context transmission) is completed, the sensor device 100 transitions to the context determination mode. In the transmission video capturing mode, the sensor device 100 acquires video data. If n seconds elapses after abnormality is detected, the sensor device 100 transitions to the context and video transmission mode.

In the context and video transmission mode, the sensor device 100 transmits local context data and the video data. If the reset button 160 is pressed, the sensor device 100 transitions to the context determination mode.

As described in the power controls (Patterns 1 and 2), the power control section 150 causes the power of the vision processing section 110 and the communication processing section 140 to exclusively turn ON. Control is performed so as to cause the power of the vision processing section 110 and the communication processing section 140 not to simultaneously turn ON. Thus, leakage of video data stored in the computation memory 112 of the vision processing section 110 by an unauthorized access is suppressed. Specific descriptions are as follows.

Firstly, communication using the communication processing section 140 is not possible during a period when video data is stored in the computation memory 112. Thus, an access from the outside to the sensor device 100 is also not possible, and leakage of video data stored in the computation memory 112 is suppressed.

Secondly, an access to the computation memory 112 is not allowed during a period when the communication processing section 140 transmits local context data. Therefore, even if the sensor device 100 receives an unauthorized access, an access to the computation memory 112 is not allowed and thus the leakage of video data is suppressed. Since the computation memory 112 is a volatile memory and video data is deleted from the computation memory 112 by power OFF of the computation memory 112, it is possible to more reduce a probability of the leakage of data.

Thirdly, when abnormality occurs, video data which is capable of being transmitted by the communication processing section 140 is limited to data stored in the transmission video memory 131 among pieces of video data which are generated by the camera 114. Therefore, it is possible to limit the quantity of video data transmitted by the communication processing section 140 to the minimum quantity desired for surveillance, when abnormality occurs. Meanwhile, the power of the vision processing section 110 is in the OFF state during a period when the power of the communication processing section 140 is in the ON state, when the abnormality occurs. Thus, a situation in which new video data is input to the transmission video memory 131 also does not occur. In this manner, even if an unauthorized access to the sensor device 100 occurs when abnormality occurs, it is possible to suppress leakage of pieces of information relating to a period other than a time when the abnormality occurs.

The power control (Pattern 1) is different from the power control (Pattern 2) in that local context data is transmitted and then the power of the transmission video holding section 130 is caused to turn ON. Since it is possible to rapidly transmit local context data exhibiting abnormality to the home server 300 and the central server 400 in the power control (Pattern 1), it is possible to support early detection of abnormality by a manager or another user. Even in a case where control of operations of the household electric appliances 500 and 600 is performed in accordance with the abnormality, the control of these operations is rapidly performed.

The power control (Pattern 2) is different from the power control (Pattern 1) in that the power of the transmission video holding section 130 is caused to turn ON before transmission of local context data. Since it is possible to acquire video data just after the occurrence of abnormality in the power control (Pattern 2), it is possible to support proper recognition in accordance with a situation of the abnormality, which is performed by the manager or another user.

Next, power control (Pattern 3) performed by the power control section 150 will be described. In the power control (Pattern 3), the power control section 150 permits the power of the vision processing section 110 and the communication processing section 140 to exclusively turn ON when abnormality occurs, and permits the power of both the vision processing section 110 and the communication processing section 140 to turn ON during a certain period after the abnormality occurs.

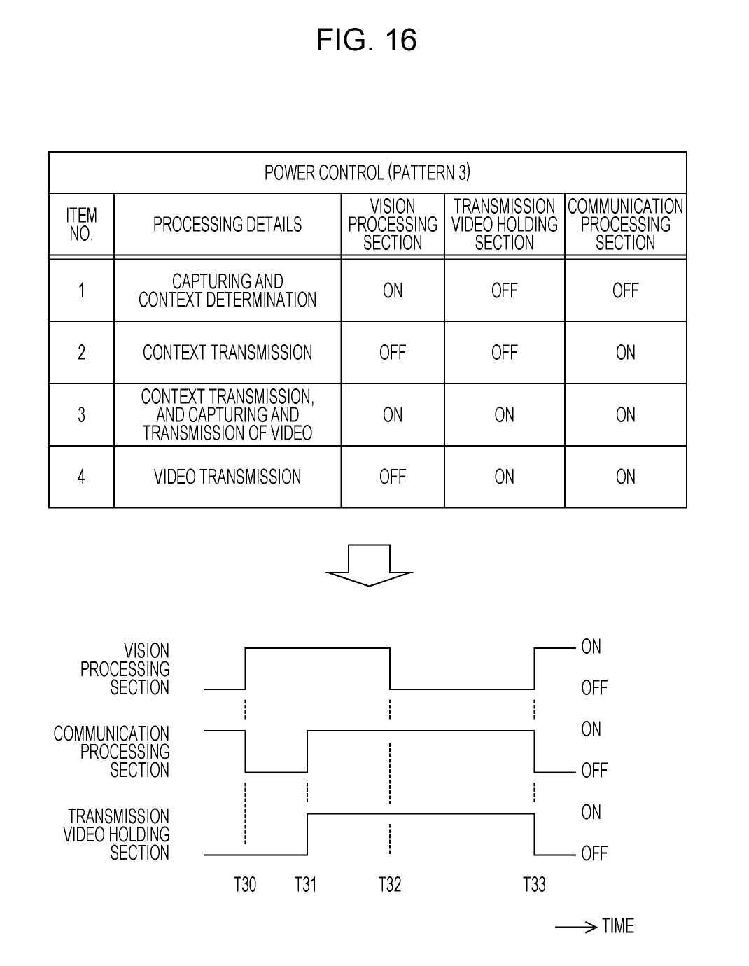

FIG. 16 is a diagram illustrating an example of the power control (Pattern 3) in the second embodiment. Similar to FIG. 10, a table in FIG. 16 represents a state of power ON and power OFF of the vision processing section 110, the transmission video holding section 130, and the communication processing section 140, for each of processing details by the sensor device 100.

A processing detail for an item number of “1” is “capturing and context determination”. In the “capturing and context determination” processing, the power of the vision processing section 110 is in the ON state, the power of the transmission video holding section 130 is in the OFF state, and the power of the communication processing section 140 is in the OFF state.

A processing detail for an item number of “2” is “context transmission”. In the context transmission processing, the power of the vision processing section 110 is in the OFF state, the power of the transmission video holding section 130 is in the OFF state, and the power of the communication processing section 140 is in the ON state.

A processing detail for an item number of “3” is “context transmission and video capturing and transmission”. Context transmission processing is performed by the communication processing section 140. The video capturing processing is performed by the vision processing section 110. Video transmission processing is performed by the communication processing section 140. In the “context transmission and video capturing and transmission” processing, the power of the vision processing section 110 is in the ON state, the power of the transmission video holding section 130 is in the ON state, and the power of the communication processing section 140 is in the ON state.

A processing detail for an item number of “4” is “video transmission”. In the video transmission processing, the power of the vision processing section 110 is in the OFF state, the power of the transmission video holding section 130 is in the ON state, and the power of the communication processing section 140 is in the ON state.

FIG. 16 also illustrates an example of time series when the power control section 150 controls power ON and power OFF of the vision processing section 110, the communication processing section 140, and the transmission video holding section 130. Time points T30, T31, T32, and T33 are timings when the power of any of the vision processing section 110, the communication processing section 140, and the transmission video holding section 130 is switched from the ON state to the OFF state, or is switched from the OFF state to the ON state. High indicates power ON. Low indicates power OFF. A direction from the left side toward the right side in FIG. 16 is a forward direction of time series.

Just before the time point T30, the power of the vision processing section 110 is in the OFF state, the power of the communication processing section 140 is in the ON state, and the power of the transmission video holding section 130 is in the OFF state. A time zone just before the time point T30 is a time zone of the context transmission processing.

At the time point T30, the power control section 150 causes the power of the communication processing section 140 to turn OFF, and causes the power of the vision processing section 110 to turn ON. The power of the transmission video holding section 130 is maintained to be in the OFF state. A time zone from the time point T30 to the time point T31 is a time zone for the “capturing and context determination” processing. Here, it is assumed that the vision processing section 110 detects an occurrence of abnormality as a result of the context determination processing. For example, the vision processing section 110 generates local context data of “Label_X” and stores the generated local context data in the context memory 121. The vision processing section 110 notifies the power control section 150 to detect the occurrence of abnormality.

At the time point T31, the power control section 150 causes the power of the transmission video holding section 130 and the communication processing section 140 to turn ON. The power of the vision processing section 110 is maintained to be in the ON state. A time zone from the time point T31 to the time point T32 is a time zone for the “context transmission and video capturing and transmission” processing. Specifically, the communication processing section 140 transmits local context data stored in the context memory 121 to the home server 300. In parallel, the vision processing section 110 stores video data generated by the camera 114, in the computation memory 112. The vision processing section 110 duplicates the video data stored in the computation memory 112, and stores the duplicated data in the transmission video memory 131. The vision processing section 110 duplicates pieces of video data which have been sequentially stored in the computation memory 112, and stores the duplicated pieces of video data in the transmission video memory 131 until the time point T32. An acquisition time n (=T32−T31) (seconds) of video data is predetermined as described above.

The power of the communication processing section 140 is caused to turn ON at the time point T31, and then the communication processing section 140 transmits a context. Therefore, the power of the transmission video holding section 130 is caused to turn ON before the communication processing section 140 transmits local context data.

The power control section 150 causes the power of the vision processing section 110 to turn OFF at the time point T32. The power of the transmission video holding section 130 and the communication processing section 140 is maintained to be in the ON state. A time zone from the time point T32 to the time point T33 is a time zone for the video transmission processing. Specifically, the communication processing section 140 transmits video data stored in the transmission video memory 131, to the home server 300. The power control section 150 restricts power ON of the vision processing section 110 until the reset button 160 is pressed after the time point T32.

The power control section 150 receives an operation of pressing the reset button 160, at the time point T33. The power control section 150 causes the power of the communication processing section 140 and the transmission video holding section 130 to turn OFF and causes the power of the vision processing section 110 to turn ON. A time zone just after the time point T33 is a time zone for the “capturing and context determination” processing.

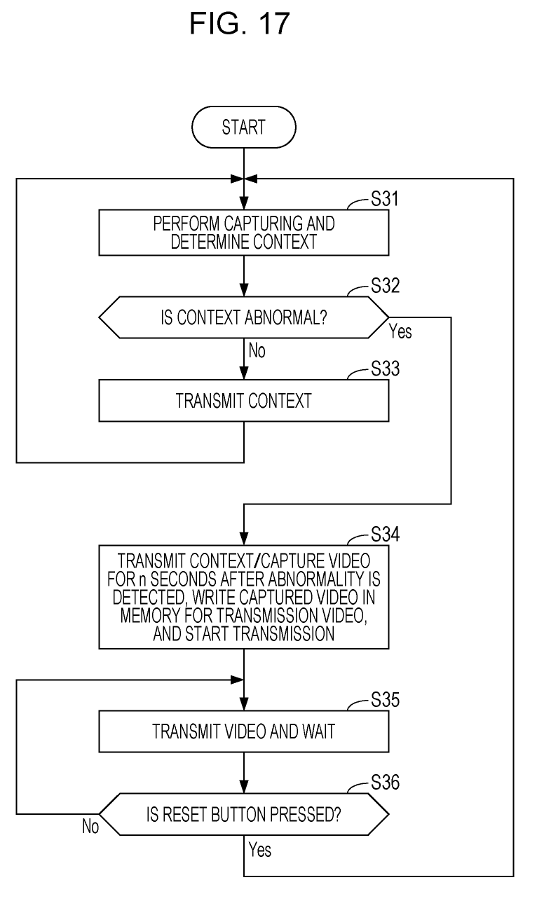

Next, an example of procedures of data transmission processing by the sensor device 100 in a case where the power control section 150 performs the power control (Pattern 3) will be described. FIG. 17 is a flowchart illustrating a transmission processing example of the power control (Pattern 3). Processes illustrated in FIG. 17 will be described below along the step number. Just before Step S31, the power of the vision processing section 110 is in the ON state, and the power of the transmission video holding section 130 and the communication processing section 140 is in the OFF state.

(S31) The vision processing section 110 captures a video by using the camera 114, and stores video data generated by capturing, in the computation memory 112. The vision processing section 110 determines a context (local context data) based on the video data stored in the computation memory 112. The vision processing section 110 stores the generated local context data in the context memory 121. The vision processing section 110 notifies power control section 150 of a determination result of the context.

(S32) The power control section 150 determines whether or not the determination result of the context of which the notification is performed from the vision processing section 110 in Step S31 indicates abnormality. In a case where the determination result indicates abnormality, the power control section 150 causes the power of the transmission video holding section 130 and the communication processing section 140 to turn ON, and then causes the process to proceed to Step S34. In a case where the determination result does not indicate abnormality, the power control section 150 causes the power of the vision processing section 110 to turn OFF and causes the power of the communication processing section 140 to turn ON, and then causes the process to proceed to Step S33.

(S33) The communication processing section 140 transmits local context data stored in the context memory 121 to the home server 300. If the transmission is completed, the communication processing section 140 notifies the power control section 150 of completion of the transmission. If the power control section 150 receives the notification of the completion of the transmission, the power control section 150 causes the power of the communication processing section 140 to turn OFF and causes the power of the vision processing section 110 to turn ON, and then causes the process to proceed to Step S31.

(S34) The communication processing section 140 transmits local context data stored in the context memory 121 to the home server 300. The vision processing section 110 captures a video for n seconds after abnormality is detected, by using the camera 114. The vision processing section 110 performs buffering of video data generated by the capturing, in the computation memory 112. The vision processing section 110 duplicates video data stored in the computation memory 112, and writes the duplicated video data in the transmission video memory 131. The communication processing section 140 starts transmission of video data written in the transmission video memory 131. If the vision processing section 110 completes acquisition of video data for n seconds, the vision processing section 110 notifies the power control section 150 of completion of acquisition of the video data. If the power control section 150 receives the notification, the power control section 150 causes the power of the vision processing section 110 to turn OFF.

(S35) The communication processing section 140 continuously transmits video data stored in the transmission video memory 131 to the home server 300, and then completes the transmission. The communication processing section 140 notifies the power control section 150 of completion of transmission of video data. The power control section 150 waits until the reset button 160 is pressed.

(S36) The power control section 150 determines whether or not the reset button 160 is pressed. In a case where the reset button 160 is pressed, the power control section 150 causes the power of the transmission video holding section 130 and the communication processing section 140 to turn OFF, and causes the power of the vision processing section 110 to turn ON. Then, the process proceeds to Step S31. In a case where the reset button 160 is not pressed, the power control section 150 causes the process to proceed to Step S35 and waits for an operation of pressing the reset button 160.

As described above, the vision processing section 110 stores pieces of video data acquired for a certain period (during n seconds after the abnormality is detected) after the abnormality is detected, in the transmission video memory 131. The communication processing section 140 transmits local context data in a time zone corresponding to the first half of the above period, and starts transmission of video data after this time zone. If the period elapses, the power control section 150 causes the power of the vision processing section 110 to turn OFF.

Similar to Step S15 in FIG. 11, in Step S35, the communication processing section 140 may automatically transmit video data just after the power of the communication processing section 140 turns ON, or after an instruction to desire a video is received by the home server 300. The communication processing section 140 may transmit video data stored in the transmission video memory 131 to the home server 300 every time a request for a video is received from the home server 300, even during a period when the communication processing section 140 waits for an operation of pressing the reset button 160, after transmission of video data is completed.

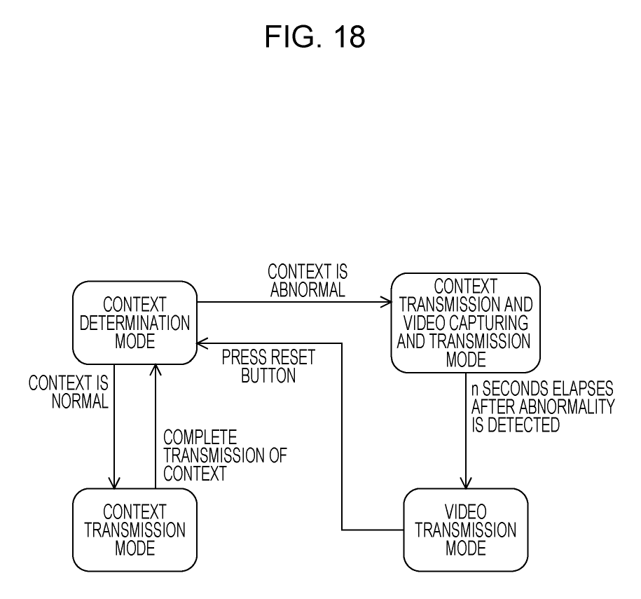

FIG. 18 is a diagram illustrating a state transition example of the sensor device in the power control (Pattern 3). Here, a state of the sensor device 100 when the sensor device 100 performs the context transmission and video capturing and transmission processing is referred to as a “context transmission and video capturing and transmission mode”.

In the context determination mode, the sensor device 100 detects context data (local context data) to be transmitted. In a case where the local context data exhibits normality, the sensor device 100 transitions to the context transmission mode. In a case where local context data exhibits abnormality in the context determination mode, the sensor device 100 transitions to the context transmission and video capturing and transmission mode.

In the context transmission mode, if transmission of local context data (context transmission) is completed, the sensor device 100 transitions to the context determination mode. The sensor device 100 acquires video data in the context transmission and video capturing and transmission mode. If n seconds elapses after abnormality is detected, the sensor device 100 transitions to the video transmission mode.

The sensor device 100 transmits video data in the video transmission mode. If the reset button 160 is pressed, the sensor device 100 transitions to the context determination mode. In the power control (Pattern 3), the power control section 150 causes the power of the vision processing section 110 and the communication processing section 140 to exclusively turn ON for the normal time. Thus, similar to the power controls (Patterns 1 and 2), leakage of video data generated by the camera 114, by an unauthorized access is suppressed.

In the power control (Pattern 3), when abnormality occurs, it is permitted that both the vision processing section 110 and the communication processing section 140 are in a state of power ON only for a certain period. Thus, the sensor device 100 performs acquisition of video data by the vision processing section 110 and transmission of local context data by the communication processing section 140 in parallel, during the period.

Thus, according to the power control (Pattern 3), similar to the power control (Pattern 1), local context data exhibiting abnormality is rapidly transmitted to the home server 300 and the central server 400. Accordingly, it is possible to support early detection of abnormality by a manager or another user. Even in a case where control of operations of the household electric appliances 500 and 600 is performed in accordance with the abnormality, the control of these operations is rapidly performed. Further, similar to the power control (Pattern 2), video data after abnormality occurs is acquired. It is possible to support proper recognition in accordance with a situation of the abnormality, which is performed by the manager or another user. That is, it is possible to achieve both of advantages obtained by the power controls (Patterns 1 and 2).

In the second embodiment, it is assumed that the power control section 150 performs power ON and power OFF in a unit of the vision processing section 110. The power control section 150 may control power ON and power OFF focusing on a memory (for example, computation memory 112) used in buffering of video data among pieces of hardware in the vision processing section 110. The reason is as follows. If buffering of video data input by the camera 114 is not performed, it is possible to suspend acquisition of video data by the vision processing section 110.

Here, currently, a connected home system is widely used. In the connected home system, in residence, the location and the activity state of a user is recognized, and a household electric appliance and the like is controlled by information, and thus a safe and pleasant residence is realized. Thus, recognition of an activity of a person is important in a state where the connected home system is realized. As described above, sensor data of a video, sound, or the like is acquired by a sensor (image sensor, microphone, or the like), and thus the activity of a person is recognized.

However, if such sensor data is used, privacy of a user may be invaded. For example, if the captured video is leaked, the user's private life may be subjected to sneak look by the third party. Therefore, realization of a system which is considerate of privacy and has no resistance even if the system is installed in the residence is desired.

Thus, the sensor device 100 uses any of the power controls (Patterns 1, 2, and 3), and thus it is possible to reduce a risk of video data generated by the camera 114 being leaked by an unauthorized access without restrictions. Thus, it is possible to suppress leakage of a video for a period other than a time when abnormality occurs, to transmit a video when the abnormality occurs, and to support proper recognition of the abnormality by a manager or the like. In this manner, it is possible to protect privacy of the user U1. In addition, it is possible to contribute to realization of a system having no resistance even if the system is installed in the residence.

### Third Embodiment

A third embodiment will be described below. Descriptions will be made focusing on a point which is different from the above-described second embodiment, and descriptions of common parts will be not repeated.

In the second embodiment, a function of acquiring video data just after abnormality occurs, by the sensor device 100 and transmitting the acquired video data to the home server 300 is described. The sensor device 100 may acquire video data before the abnormality occurs, and may transmit the acquired video data to the home server 300 when the abnormality occurs. Thus, in the third embodiment, a function of transmitting video data before the abnormality occurs, to the home server 300 is provided by the sensor device 100.

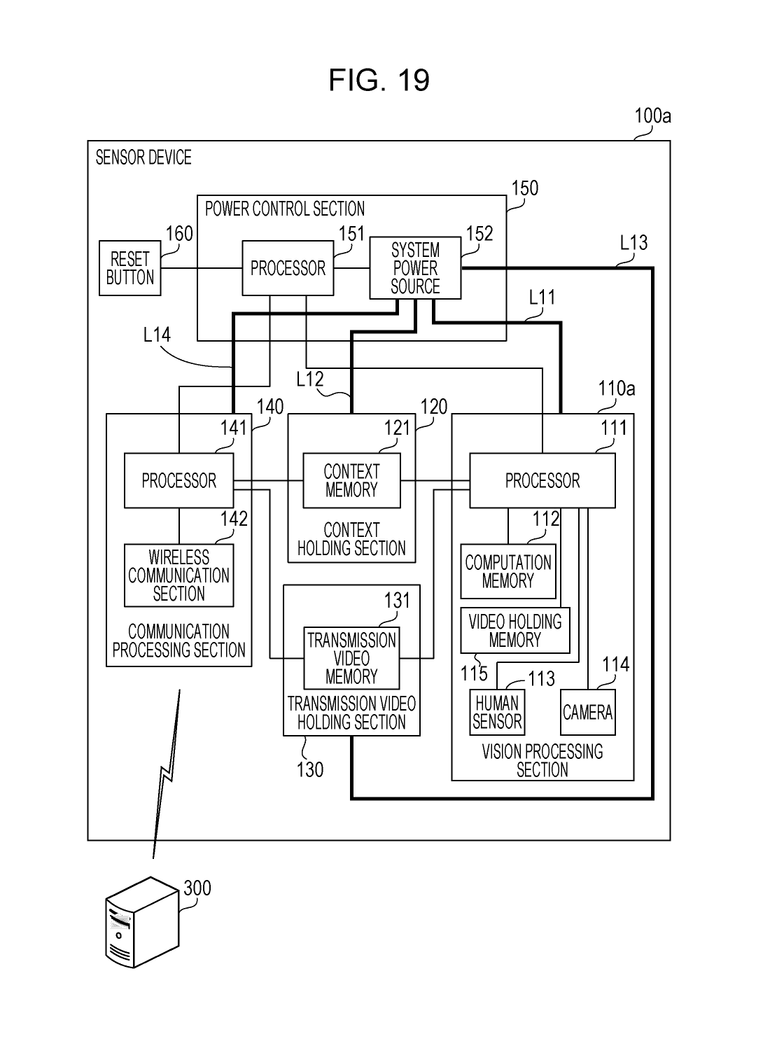

FIG. 19 is a diagram illustrating a hardware example of the sensor device in the third embodiment. In the third embodiment, a sensor device 100a is used instead of the sensor device 100. The sensor device 100a includes a vision processing section 110a instead of the vision processing section 110. The vision processing section 110a is different from the vision processing section 110 in that the vision processing section 110a further includes a video holding memory 115 in addition to the hardware of the vision processing section 110.

The video holding memory 115 is a storage device for holding the previous video data which has been generated by the camera 114 before the current time point. The video holding memory 115 is a volatile memory similar to the computation memory 112. For example, an SRAM may be used as the video holding memory 115. The computation memory 112 and the video holding memory 115 may be realized as two storage areas which are individually ensured on the same memory, respectively.

Video data for some seconds (a is the positive real number) before the current time point is stored in the video holding memory 115. The value of a is predetermined as the length of a time desired for surveillance. The memory capacity of the video holding memory 115 is set to have a size of video data for a seconds. That is, the memory capacity of the video holding memory 115 may have the minimum size which is capable of storing video data for the seconds.

In this case, the memory capacity of the transmission video memory 131 is set to have a size of video data for (a+n) seconds. That is, the memory capacity of the transmission video memory 131 may have the minimum size which is capable of storing video data for (a+n) seconds.

Here, in the sensor device 100a, before the sensor device 100a transmits local context data exhibiting abnormality to the home server 300, the power of the transmission video holding section 130 is caused to turn ON, and video data just after the occurrence of abnormality is acquired. That is, in the sensor device 100a, control corresponding to the power control (Pattern 1) described in the second embodiment is not performed. The reason is as follows. If the power of the vision processing section 110a turns OFF, pieces of the previous video data stored in the video holding memory 115 are deleted.

In the sensor device 100a, control corresponding to the power controls (Patterns 2 and 3) described in the second embodiment are performed. Control of the sensor device 100a, which corresponds to the power control (Pattern 2) is referred to as power control (Pattern A). Control of the sensor device 100a, which corresponds to the power control (Pattern 3) is referred to as power control (Pattern B).

Specific control details will be described below in an order of Patterns A and B. Regarding processing details of the power control (Pattern A), a state of power ON and power OFF of the vision processing section 110a, the transmission video holding section 130, and the communication processing section 140 and state transition of the sensor device 100a are similar to a case of the power control (Pattern 2) illustrated in FIGS. 13 and 15.

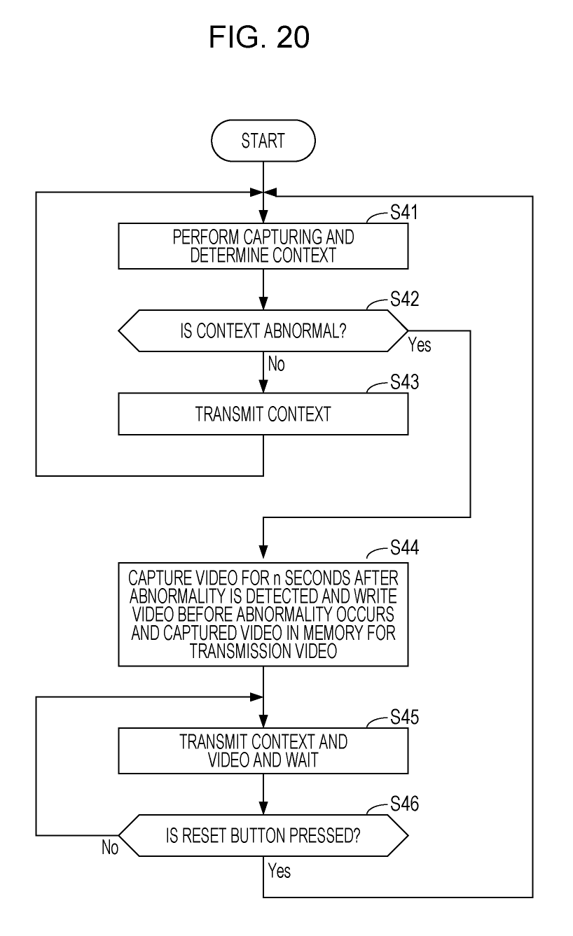

Next, an example of procedures of data transmission processing by the sensor device 100a in a case where the power control section 150 performs the power control (Pattern A) will be described. FIG. 20 is a flowchart illustrating a transmission processing example of the power control (Pattern A). Processes illustrated in FIG. 20 will be described below along the step number. Just before Step S41, the power of the vision processing section 110a is in the ON state, and the power of the transmission video holding section 130 and the communication processing section 140 is in the OFF state.

(S41) The vision processing section 110a captures a video by using the camera 114, and stores video data generated by capturing, in the computation memory 112. The vision processing section 110a determines a context (local context data) based on video data stored in the computation memory 112. The vision processing section 110a stores the generated local context data in the context memory 121. The vision processing section 110a duplicates video data stored in the computation memory 112 and stores the duplicated video data in the video holding memory 115. The video holding memory 115 holds video data for a seconds in the past before the current time point. The vision processing section 110a notifies the power control section 150 of a determination result of a context.

Here, the vision processing section 110a determines a context in a period of a seconds or longer. The vision processing section 110a captures a video by the camera 114 at a predetermined frame rate, and normally accumulates pieces of video data in the video holding memory 115.

(S42) The power control section 150 determines whether or not the determination result of a context, of which a notification is performed from the vision processing section 110a in Step S41 is abnormal. In a case where the determination result indicates abnormality, the power control section 150 causes the power of the transmission video holding section 130 to turn ON, and then causes the process to proceed to Step S44. In a case where the determination result does not indicate abnormality, the power control section 150 causes the power of the vision processing section 110a to turn OFF and causes the power of the communication processing section 140 to turn ON, and then causes the process to proceed to Step S43.

(S43) The communication processing section 140 transmits local context data stored in the context memory 121 to the home server 300. If the transmission is completed, the communication processing section 140 notifies the power control section 150 of completion of the transmission. If the power control section 150 receives the notification of the completion of the transmission, the power control section 150 causes the power of the communication processing section 140 to turn OFF and causes the power of the vision processing section 110a to turn ON, and then causes the process to proceed to Step S41.

(S44) The vision processing section 110a captures a video for n seconds after abnormality is detected by using the camera 114. The vision processing section 110a performs buffering of video data generated by capturing, in the computation memory 112. The vision processing section 110a writes video data for a seconds, which is stored in the video holding memory 115 and is data before the abnormality occurs, in the transmission video memory 131. The vision processing section 110a duplicates video data stored in the computation memory 112, and writes the duplicated video data in the transmission video memory 131. If the vision processing section 110a completes acquisition of video data for n seconds, the vision processing section 110a notifies the power control section 150 to complete acquisition of video data. If the power control section 150 receives the notification, the power control section 150 causes the power of the vision processing section 110a to turn OFF, and causes the power of the communication processing section 140 to turn ON.

(S45) The communication processing section 140 transmits local context data stored in the context memory 121 to the home server 300. The communication processing section 140 transmits video data (video data for (a+n) seconds) stored in the transmission video memory 131 to the home server 300. The communication processing section 140 notifies the power control section 150 of completion of transmission of video data. The power control section 150 waits until the reset button 160 is pressed.

(S46) The power control section 150 determines whether or not the reset button 160 is pressed. In a case where the reset button 160 is pressed, the power control section 150 causes the power of the transmission video holding section 130 and the communication processing section 140 to turn OFF, and causes the power of the vision processing section 110a to turn ON. Then, the process proceeds to Step S41. In a case where the reset button 160 is not pressed, the power control section 150 causes the process to proceed to Step S45 and waits for an operation of pressing the reset button 160.

Similar to Step S15 in FIG. 11, in Step S45, the communication processing section 140 may automatically transmit video data just after the power of the communication processing section 140 turns ON, or after an instruction to desire a video is received by the home server 300. The communication processing section 140 may transmit video data stored in the transmission video memory 131 to the home server 300 every time a request for a video is received from the home server 300, even during a period when the communication processing section 140 waits for an operation of pressing the reset button 160, after transmission of video data is completed.

Next, a case of power control (Pattern B) will be described. Regarding processing details of the power control (Pattern B), a state of power ON and power OFF of the vision processing section 110a, the transmission video holding section 130, and the communication processing section 140 and state transition of the sensor device 100a are similar to the case of the power control (Pattern 3) illustrated in FIGS. 16 and 18.

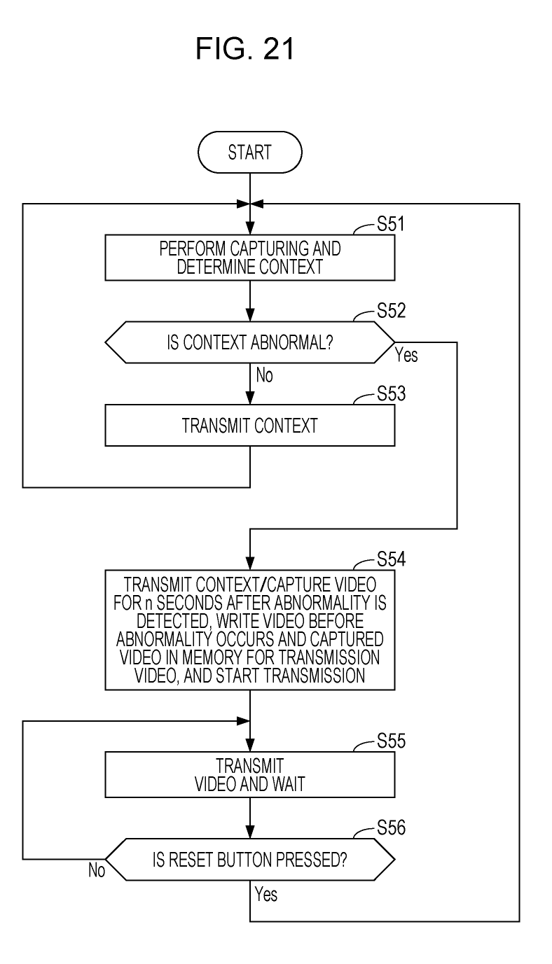

Next, an example of procedures of data transmission processing by the sensor device 100a in a case where the power control section 150 performs the power control (Pattern B) will be described. FIG. 21 is a flowchart illustrating a transmission processing example of the power control (Pattern B). Processes illustrated in FIG. 21 will be described below along the step number. Just before Step S51, the power of the vision processing section 110a is in the ON state, and the power of the transmission video holding section 130 and the communication processing section 140 is in the OFF state.

(S51) The vision processing section 110a captures a video by using the camera 114, and stores video data generated by capturing, in the computation memory 112. The vision processing section 110a determines a context (local context data) based on video data stored in the computation memory 112. The vision processing section 110a stores the generated local context data in the context memory 121. The vision processing section 110a duplicates video data stored in the computation memory 112 and stores the duplicated video data in the video holding memory 115. The video holding memory 115 holds video data for a seconds in the past before the current time point. The vision processing section 110a notifies the power control section 150 of a determination result of a context.

Here, the vision processing section 110a determines a context in a period of a seconds or longer. The vision processing section 110a captures a video by the camera 114 at a predetermined frame rate, and normally accumulates pieces of video data in the video holding memory 115.

(S52) The power control section 150 determines whether or not the determination result of a context, of which a notification is performed from the vision processing section 110a in Step S51 is abnormal. In a case where the determination result indicates abnormality, the power control section 150 causes the power of the transmission video holding section 130 and the communication processing section 140 to turn ON, and then causes the process to proceed to Step S54. In a case where the determination result does not indicate abnormality, the power control section 150 causes the power of the vision processing section 110a to turn OFF and causes the power of the communication processing section 140 to turn ON, and then causes the process to proceed to Step S53.

(S53) The communication processing section 140 transmits local context data stored in the context memory 121 to the home server 300. If the transmission is completed, the communication processing section 140 notifies the power control section 150 of completion of the transmission. If the power control section 150 receives the notification of the completion of the transmission, the power control section 150 causes the power of the communication processing section 140 to turn OFF and causes the power of the vision processing section 110a to turn ON, and then causes the process to proceed to Step S51.

(S54) The communication processing section 140 transmits local context data stored in the context memory 121 to the home server 300. The vision processing section 110a captures a video for n seconds after the abnormality is detected, by using the camera 114. The vision processing section 110a performs buffering of video data generated by capturing, in the computation memory 112. The vision processing section 110a writes video data for a seconds, which is stored in the video holding memory 115 and is data before the abnormality occurs, in the transmission video memory 131. The vision processing section 110a duplicates video data stored in the computation memory 112, and writes the duplicated video data in the transmission video memory 131. The communication processing section 140 starts transmission of video data written in the transmission video memory 131. If the vision processing section 110a completes acquisition of video data for n seconds, the vision processing section 110a notifies the power control section 150 to complete acquisition of video data. If the power control section 150 receives the notification of the completion of the transmission, the power control section 150 causes the power of the vision processing section 110a to turn OFF.

(S55) The communication processing section 140 continuously transmits video data (video data for (a+n) seconds) stored in the transmission video memory 131 to the home server 300, and then completes the transmission. The communication processing section 140 notifies the power control section 150 of completion of transmission of video data. The power control section 150 waits until the reset button 160 is pressed.

(S56) The power control section 150 determines whether or not the reset button 160 is pressed. In a case where the reset button 160 is pressed, the power control section 150 causes the power of the transmission video holding section 130 and the communication processing section 140 to turn OFF, and causes the power of the vision processing section 110a to turn ON. Then, the process proceeds to Step S51. In a case where the reset button 160 is not pressed, the power control section 150 causes the process to proceed to Step S55 and waits for an operation of pressing the reset button 160.

Similar to Step S15 in FIG. 11, in Step S55, the communication processing section 140 may automatically transmit video data just after the power of the communication processing section 140 turns ON, or after an instruction to desire a video is received by the home server 300. The communication processing section 140 may transmit video data stored in the transmission video memory 131 to the home server 300 every time a request for a video is received from the home server 300, even during a period when the communication processing section 140 waits for an operation of pressing the reset button 160, after transmission of video data is completed.

As described above, according to the sensor device 100a, it is possible to protect privacy of the user U1 and to transmit only video data after the abnormality occurs, to the home server 300. Therefore, it is possible to support detailed recognition of a situation of the abnormality, which is performed by the manager who uses the central server 400 or another user who uses a terminal apparatus communicating with the home server 300.

In the third embodiment, it is assumed that the power control section 150 performs power ON and power OFF in a unit of the vision processing section 110a. The power control section 150 may control power ON and power OFF focusing on a memory (for example, computation memory 112 and video holding memory 115) used in buffering of video data among pieces of hardware in the vision processing section 110a. The reason is as follows. If buffering of video data input by the camera 114 is not performed, it is possible to suspend acquisition of video data by the vision processing section 110a.

In the second and third embodiments, an example in which video data which is acquired by the camera 114 is used as the sensor data is described. However, the sensor data may be audio data generated by a microphone, temperature distribution data generated by a temperature sensor, or the like. Details of the abnormality, which is detected by the vision processing sections 110 and 110a may be also abnormality such as injury of the user U1. As the details of the abnormality, various contents such as abnormality (for example, abnormal noise, abnormal fever, fire, and the like) of house facilities or a household electric appliance, intrusion of a suspicious person when the user U1 is absent or a key of a house is locked are considered.

The process of the processing section 1d, the process of the communication section 1e, the first memory, and the third memory are enabled or disabled by power ON or OFF from the power control section 1f, respectively.

The process of the processing section 1d, the process of the communication section 1e may be enabled or disabled by a signal from the power control section 1f, respectively.

Additional Notes

Note 1. A transmission apparatus comprising: a processor configured to: disable access to a third memory, store input first data in the first memory, generate second data based on the first data, store the second data in a second memory, and in a case where the second data exhibits abnormality, store, in the third memory, the first data stored in the first memory, enable a process of transmitting, perform the process of transmitting the second data stored in the second memory and transmitting the first data stored in the third memory, and exclusively enable access to the first memory and the process of the transmitting, and enable the access to the third memory in accordance with the abnormality.

Note 2. The transmission apparatus according to note 1, wherein, in a case where the second data exhibits abnormality, the processor enables the access to the third memory before the second data is transmitted by the process of the transmitting.

Note 3. The transmission apparatus according to note 2, wherein the processor allows both the access to the first memory and the process of the transmitting during a certain period after the allowing the access to the third memory, and enables both the access to the first memory and the transmitting during the period.

Note 4. The transmission apparatus according to note 3, wherein the processor stores the first data input during the period, in the third memory, the processor performs the process of transmitting the second data in a first time zone in the period and starts the process of transmitting the first data after the first time zone, and the processor disables the access to the first memory after the period elapses.

Note 5. The transmission apparatus according to note 2, wherein the processor stores the third data input before a current time point, in a fourth memory which is controlled to enable and disable access along with the first memory, and stores the third data in addition to the first data, in the third memory in accordance with the abnormality, and the processor performs the process of transmitting the first data and the third data when the processor enables the process of the transmitting.

Note 6. The transmission apparatus according to note 1, wherein, in a case where the second data exhibits abnormality, the processor enables access to the third memory after the processor performs the process of transmitting the second data.

Note 7. The transmission apparatus according to note 1, wherein, after the processor performs the process of transmitting the first data, the processor restricts the access to the first memory until receiving an input of a predetermined operation by a user, and when the input of the operation is received, the processor disables a process of the transmitting and the access to the third memory and enables the access to the first memory.

Note 8. The transmission apparatus according to note 1, wherein the processor disables a sensor in an input source of the first data when disabling the access to the first memory, and the processor enables the sensor when enabling the access to the first memory.

Note 9. The transmission apparatus according to note 1, wherein the processor disables a process of the disabling and the enabling when the processor disabling the access to the first memory, and the processor enables the process of the disabling and the enabling when the processor enable the access to the first memory.

Note 10. The transmission apparatus according to note 1, wherein the first data is image data.

Note 11. The transmission apparatus according to note 1, wherein the processor includes two or more processors, and a first processor of the two or more processors is configured to control the enabling and the disabling.

Note 12. An information processing system comprising: a transmission apparatus including a processor that disables access to a third memory, stores input first data in a first memory, generates second data based on the first data, stores the second data in a second memory, and in a case where the second data exhibits abnormality, enable access to the third memory and store, in the third memory, the first data stored in the first memory, performs a process of transmitting the second data stored in the second memory and transmitting the first data stored in the third memory, and exclusively enables the access to the first memory and the process of the transmitting, and enables the access to the third memory in accordance with the abnormality; and an information processing apparatus configured to receive the first data and the second data and control another device in accordance with the second data.

Note 13. The information processing system according to note 12, wherein the processor includes two or more processors, and a first processor of the two or more processors is configured to control the enabling and the disabling.

Note 14. A method of transmitting data by a transmission apparatus, the method comprising: causing a first processor to store input first data in a first memory, generate second data based on the first data, and store the second data in a second memory; causing a second processor to cause power of a third memory to turn ON in a case where the second data exhibits abnormality; causing the first processor to store the first data stored in the first memory, in the third memory; causing the second processor to cause power of the first memory to turn OFF and to cause power of a processor configured to transmit the second data stored in the second memory to turn ON; and causing the first processor to transmit the first data stored in the third memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a processor configured to:
disable access to a third memory,
store input first data in the first memory,
generate second data based on the first data,
store the second data in a second memory, and
in a case where the second data exhibits abnormality, store, in the third memory, the first data stored in the first memory,
enable a process of transmitting,
perform the process of transmitting the second data stored in the second memory and transmitting the first data stored in the third memory, and
exclusively enable access to the first memory and the process of the transmitting, and enable the access to the third memory in accordance with the abnormality.

2. The transmission apparatus according to claim 1,
wherein, in a case where the second data exhibits abnormality, the processor enables the access to the third memory before the second data is transmitted by the process of the transmitting.

3. The transmission apparatus according to claim 2,
wherein the processor allows both the access to the first memory and the process of the transmitting during a certain period after the allowing the access to the third memory, and enables both the access to the first memory and the transmitting during the period.

4. The transmission apparatus according to claim 3,
wherein the processor stores the first data input during the period, in the third memory,
the processor performs the process of transmitting the second data in a first time zone in the period and starts the process of transmitting the first data after the first time zone, and
the processor disables the access to the first memory after the period elapses.

5. The transmission apparatus according to claim 2,
wherein the processor stores the third data input before a current time point, in a fourth memory which is controlled to enable and disable access along with the first memory, and stores the third data in addition to the first data, in the third memory in accordance with the abnormality, and
the processor performs the process of transmitting the first data and the third data when the processor enables the process of the transmitting.

6. The transmission apparatus according to claim 1,
wherein, in a case where the second data exhibits abnormality, the processor enables access to the third memory after the processor performs the process of transmitting the second data.

7. The transmission apparatus according to claim 1,
wherein, after the processor performs the process of transmitting the first data, the processor restricts the access to the first memory until receiving an input of a predetermined operation by a user, and
when the input of the operation is received, the processor disables a process of the transmitting and the access to the third memory and enables the access to the first memory.

8. The transmission apparatus according to claim 1,
wherein the processor disables a sensor in an input source of the first data when disabling the access to the first memory, and the processor enables the sensor when enabling the access to the first memory.

9. The transmission apparatus according to claim 1,
wherein the processor disables a process of the disabling and the enabling when the processor disabling the access to the first memory, and
the processor enables the process of the disabling and the enabling when the processor enable the access to the first memory.

10. The transmission apparatus according to claim 1,
wherein the first data is image data.

11. The transmission apparatus according to claim 1,
wherein the processor includes three or more processors, and first another processor of the two or more processors is configured to control the enabling and the disabling.

12. The transmission apparatus according to claim 11, wherein
to disable the access to the third memory by the first another processor is to cause power of the third memory to turn OFF,
to enable the access to the first memory by the first another processor is to cause power of the first memory to turn ON, and
to enable the process of the transmitting by the first another processor is to cause power of the second another processor to turn ON, and perform, by the second another processor, the process of transmitting the second data stored in the second memory and transmitting the first data stored in the third memory.

13. An information processing system comprising:
a transmission apparatus including a processor that
disables access to a third memory,
stores input first data in a first memory,
generates second data based on the first data,
stores the second data in a second memory, and
in a case where the second data exhibits abnormality, enable access to the third memory and store, in the third memory, the first data stored in the first memory,
performs a process of transmitting the second data stored in the second memory and transmitting the first data stored in the third memory, and
exclusively enables the access to the first memory and the process of the transmitting, and enables the access to the third memory in accordance with the abnormality; and
an information processing apparatus configured to receive the first data and the second data and control another device in accordance with the second data.

14. The information processing system according to claim 13,
wherein the processor includes three or more processors, and a first another processor of the two or more processors is configured to control the enabling and the disabling.

15. The information processing system according to claim 14, wherein
to disable the access to the third memory by the first another processor is to cause power of the third memory to turn OFF,
to enable the access to the first memory by the first another processor is to cause power of the first memory to turn ON, and
to enable the process of the transmitting by the first another processor is to cause power of the second another processor to turn ON, and perform, by the second another processor, the process of transmitting the second data stored in the second memory and transmitting the first data stored in the third memory.

16. A method of transmitting data by a transmission apparatus, the method comprising:
causing a first processor to store input first data in a first memory, generate second data based on the first data, and store the second data in a second memory;
causing a second processor to cause power of a third memory to turn ON in a case where the second data exhibits abnormality;
causing the first processor to store the first data stored in the first memory, in the third memory;
causing the second processor to cause power of the first memory to turn OFF and to cause power of a processor configured to transmit the second data stored in the second memory to turn ON; and
causing the first processor to transmit the first data stored in the third memory.
